(19) United States
(12) Patent Application Publication
(10) Pub. No.: US 2025/0353400 A1
(43) Pub. Date: Nov. 20, 2025

(54) CHARGING PLANNING METHOD AND CHARGING PLANNING DEVICE

(71) Applicant: Panasonic Intellectual Property Management Co., Ltd., Osaka (JP)

(72) Inventor: Makoto OZONE, Osaka (JP)

(21) Appl. No.: 19/290,028

(22) Filed: Aug. 4, 2025

Related U.S. Application Data
(63) Continuation of application No. PCT/JP2023/047064, filed on Dec. 27, 2023.

(30) Foreign Application Priority Data
Feb. 22, 2023 (JP) 2023-026485

(51) Int. Cl. B60L 53/63; B60L 53/64; B60L 53/67

(52) U.S. Cl. CPC B60L 53/63; B60L 53/64; B60L 53/67

(57) ABSTRACT

A charging planning method is performed by a charging planning device, and includes carrying out a first charging plan for a predetermined period for each of a plurality of charging sites that are connected to a power system and that charge electric vehicles. first charging plan is carried out such that a total of power to be received from the power system at the plurality of charging sites is less than or equal to an upper limit that is less than or equal to a power capacity of system facilities.

### BACKGROUND

### 1. Technical Field

The present disclosure relates to a charging planning method performed by a charging planning device, etc.

### 2. Description of the Related Art

Japanese Patent No. 6995138 indicates that each charging station has a station power limit value, in order to maintain maximum total power.

### SUMMARY

When charging is restricted, however, it may be difficult to meet the demand for charging. When charging is not restricted, on the other hand, the amount of power supplied for charging from a power system may exceed the power capacity of system facilities in the power system, and the power supply may be stopped. Thus, it is not easy to achieve both stable operation of the power system and efficient charging of electric vehicles.

One non-limiting and exemplary embodiment provides a charging planning method, etc., capable of achieving both stable operation of a power system and efficient charging of electric vehicles.

In one general aspect, the techniques disclosed here feature a charging planning method performed by a charging planning device, including carrying out a first charging plan for a predetermined period for each of a plurality of charging sites that are connected to a power system and that charge electric vehicles, in which the first charging plan is carried out such that a total of power to be received from the power system at the plurality of charging sites is less than or equal to an upper limit that is less than or equal to a power capacity of system facilities.

These comprehensive or specific aspects may be implemented by a system, a device, a method, an integrated circuit, a computer program, or a non-transitory computer-readable storage medium such as a compact disc read only memory (CD-ROM), or may be implemented by any combination of a system, a device, a method, an integrated circuit, a computer program, and a storage medium.

With the charging planning method, etc., according to an aspect of the present disclosure, it is possible to achieve both stable operation of a power system and efficient charging of electric vehicles.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a block diagram illustrating an example of the configuration of a power control system according to an embodiment;

FIG. 2 is a block diagram illustrating an example of the configuration of a charging planning device according to the embodiment;

FIG. 3 is a flowchart illustrating an example of operation of the charging planning device according to the embodiment;

FIG. 4 is a conceptual diagram illustrating a first specific example of time slots in which electric vehicles are chargeable based on an operation plan;

FIG. 5 is a conceptual diagram illustrating a first specific example of a charging plan corresponding to the presence or absence of control based on an upper limit value;

FIG. 6 is a conceptual diagram illustrating a second specific example of time slots in which electric vehicles are chargeable based on an operation plan;

FIG. 7 is a conceptual diagram illustrating a second specific example of a charging plan corresponding to the presence or absence of control based on an upper limit value;

FIG. 8 is a block diagram illustrating a specific example of the configuration of a power control system according to an embodiment;

FIG. 9 is a sequence diagram illustrating a first specific example of operation of the power control system according to the embodiment;

FIG. 10 is a sequence diagram illustrating a second specific example of operation of the power control system according to the embodiment;

FIG. 11 is a sequence diagram illustrating a third specific example of operation of the power control system according to the embodiment; and

FIG. 12 is a sequence diagram illustrating a fourth specific example of operation of the power control system according to the embodiment.

### DETAILED DESCRIPTIONS

It is expected that electric vehicles (EVs) will be widely used as trucks, buses, etc., in the future. It is considered that these electric vehicles will be applied to delivery businesses, etc., as EV fleets. Accordingly, it is expected that the charging of these electric vehicles will increase the load on system facilities in a power system, and there will be a demand that exceeds the power capacity of the system facilities. On the other hand, the expansion of the system facilities is extremely costly. Therefore, it is not easy to achieve both stable operation of the power system and efficient charging of the electric vehicles.

Specifically, when the amount of power supplied from a power system to a plurality of charging sites exceeds the power capacity of system facilities in the power system, for example, the power supply from the power system may be stopped. This makes it difficult to charge electric vehicles at each charging site, which may interfere with the operation of the electric vehicles.

In order to avoid the above situation, a method of restricting the amount of power supplied from a power system to each charging site to an upper limit value or less may be used. With this method, however, enough power may not be obtained from the power system, which may interfere with the operation of the electric vehicles. Furthermore, the amount of power supplied from the power system to each charging site may be restricted, even if there is an allowance in the power capacity of the system facilities for the entirety of the plurality of charging sites. That is, there is a possibility that power resources may not be used effectively.

Thus, a first aspect provides a charging planning method performed by a charging planning device, including carrying out a first charging plan for a predetermined period for each of a plurality of charging sites that are connected to a power system and that charge electric vehicles, in which the first charging plan is carried out such that a total of power to be received from the power system at the plurality of charging sites is less than or equal to an upper limit that is less than or equal to a power capacity of system facilities.

This makes it possible to make the total of the power to be supplied from the power system to the plurality of charging sites less than or equal to the upper limit that is less than or equal to the power capacity of the system facilities, contributing to the stable operation of the power system. In addition, the upper limit is given for the total of the power to be received from the power system at the plurality of charging sites, rather than for the power to be received from the power system at one charging site, making it possible to flexibly plan charging for the plurality of charging sites in the range of the upper limit. Thus, it is possible to achieve both stable operation of the power system and efficient charging of electric vehicles.

A second aspect may provide the charging planning method according to the first aspect, in which the upper limit is provided for each time slot within the predetermined period.

This makes it possible to change the upper limit of the total of the power to be supplied from the power system to the plurality of charging sites for each time slot. Thus, it is possible to flexibly plan charging in the range of the upper limit adaptively determined for the status of the power system or the status of the power demand in each time slot.

A third aspect may provide the charging planning method according to the first or second aspect, in which in the first charging plan, charging of the electric vehicles is planned such that a ratio of power to be received from the power system to charging power of at least one charger provided at a charging site is greater in a time slot with a lower unit power price than in a time slot with a higher unit power price, among two time slots with different unit power prices.

Consequently, for the first charging plan, it is possible to plan charging such that more power is supplied from the power system to the charging site in a time slot in which the load on the power system is low and the power cost is low. Thus, it is possible to contribute to the stable operation of the power system. In addition, it is possible to contribute to the reduction of the charging cost at the charging site at which charging takes place.

A fourth aspect may provide the charging planning method according to the first or second aspect, in which in the first charging plan, charging of the electric vehicles is planned such that a ratio of power to be received from a distributed power source provided at a charging site to charging power of at least one charger provided at the charging site is greater in a time slot with a higher unit power price than in a time slot with a lower unit power price, among two time slots with different unit power prices.

Consequently, for the first charging plan, it is possible to plan charging such that more power is supplied from the distributed power source in a time slot in which the load on the power system is high and the power cost is high. In addition, if the distributed power source is a power source with a lower power cost than the power system such as a solar power generation device, it is possible to contribute to the reduction of the charging cost at the charging site.

A fifth aspect may provide the charging planning method according to any one of the first to fourth aspects, further including acquiring an operation plan for the electric vehicles, in which the first charging plan is carried out such that a power demand for the electric vehicles is met in a time slot in which the electric vehicles are chargeable and which is set on a basis of the operation plan for the electric vehicles.

This makes it possible to plan charging of the electric vehicles in an appropriate time slot on the basis of the operation plan for the electric vehicles. Thus, it is possible to operate the electric vehicles on the basis of the operation plan.

A sixth aspect may provide the charging planning method according to the fifth aspect, further including determining a charger to charge the electric vehicles on a basis of a time slot in which the electric vehicles are chargeable.

This makes it possible to adaptively allocate the charger to the electric vehicles. Thus, it is possible to plan charging more flexibly.

A seventh aspect may provide the charging planning method according to any one of the first to sixth aspects, further including receiving information indicating the upper limit from a management system that manages power to be transmitted from the power system.

This makes it possible to acquire an appropriate upper limit from the management system. Thus, it is possible to plan charging in accordance with the appropriate upper limit acquired from the management system.

An eighth aspect may provide the charging planning method according to the seventh aspect, further including: carrying out a second charging plan such that a power demand for the electric vehicles for the predetermined period is met for each of the plurality of charging sites without considering the upper limit, the second charging plan including planning first power to be received from the power system, which is included in charging power for the electric vehicles; and transmitting a power receiving plan to the management system, the power receiving plan being a plan for power to be received from the power system, including the first power to be received, for each of the plurality of charging sites, in which the upper limit is determined by the management system on a basis of the power receiving plan received by the management system.

This makes it possible to plan charging in the range of the upper limit determined by the management system on the basis of the power demand without considering the upper limit. Thus, it is possible to plan charging in the range of the upper limit that reflects the original power demand.

A ninth aspect may provide the charging planning method according to any one of the first to sixth aspects, further including: carrying out a second charging plan such that a power demand for the electric vehicles for the predetermined period is met for each of the plurality of charging sites without considering the upper limit, the second charging plan including planning first power to be received from the power system, which is included in charging power for the electric vehicles; and determining the upper limit on a basis of a power receiving plan, which is a plan for power to be received from the power system, including the first power to be received, for each of the plurality of charging sites.

This makes it possible to determine the upper limit on the basis of the power demand without considering the upper limit. Thus, it is possible to reflect the original power demand in the upper limit.

A tenth aspect may provide the charging planning method according to any one of the first to sixth aspects, further including determining the upper limit on a basis of the power capacity of the system facilities and power to be transmitted from the power system.

This makes it possible to plan charging in the range of the upper limit which is based on the power capacity of the system facilities and the power to be transmitted from the power system. Thus, it is possible to contribute to the stable operation of the power system.

An eleventh aspect may provide the charging planning method according to the eighth or ninth aspect, in which the upper limit includes a first upper limit value that is set for a first time slot within the predetermined period, the first upper limit value being less than a peak value of the total of the power to be received from the power system at the plurality of charging sites in the first time slot.

This makes it possible to apply the first upper limit value to the first time slot as the upper limit, the first upper limit value being less than the peak value in the first time slot of the power receiving plan without considering the upper limit. Thus, the power to be received in the first time slot is suppressed, making it possible to contribute to the stable operation of the power system.

A twelfth aspect may provide the charging planning method according to the eleventh aspect, in which in the first charging plan, the power receiving plan is corrected such that the total in the first time slot is less than or equal to the first upper limit, and a charging plan for at least one of the plurality of charging sites is corrected such that at least a part of an amount of power to be received that has been decreased by correcting the power receiving plan is compensated for with power from a distributed power source provided at the charging site.

This makes it possible to compensate for the amount of decrease in the power to be received in the first time slot with the power from the distributed power source. Thus, it is possible to meet the demand for charging of the electric vehicles. In addition, if the distributed power source is a power source with a lower power cost than the power system such as a solar power generation device, it is possible to contribute to the reduction of the charging cost at the charging site.

A thirteenth aspect may provide the charging planning method according to the eleventh aspect, in which in the first charging plan, the power receiving plan is corrected such that the total in the first time slot is less than or equal to the first upper limit, and a charging plan for at least one of the plurality of charging sites is corrected such that at least a part of an amount of power to be received that has been decreased by correcting the power receiving plan is compensated for with power to be received from the power system in a time slot different from the first time slot.

This makes it possible to compensate for the amount of decrease in the power to be received in the first time slot with the power to be received in a different time slot. Thus, it is possible to meet the demand for charging of the electric vehicles.

A fourteenth aspect may provide the charging planning method according to the eighth or ninth aspect, in which in the second charging plan, charging of the electric vehicles is planned such that a ratio of power to be received from the power system to charging power of at least one charger provided at a charging site is greater in a time slot with a lower unit power price than in a time slot with a higher unit power price, among two time slots with different unit power prices.

Consequently, for the second charging plan, it is possible to plan charging such that more power is supplied from the power system to the charging site in a time slot in which the load on the power system is low and the power cost is low. Thus, it is possible to contribute to the stable operation of the power system. In addition, it is possible to contribute to the reduction of the charging cost at the charging site.

A fifteenth aspect may provide the charging planning method according to the eighth or ninth aspect, in which in the second charging plan, charging of the electric vehicles is planned such that a ratio of power to be received from a distributed power source provided at a charging site to charging power of at least one charger provided at the charging site is greater in a time slot with a higher unit power price than in a time slot with a lower unit power price, among two time slots with different unit power prices.

Consequently, for the second charging plan, it is possible to plan charging such that more power is supplied from the distributed power source in a time slot in which the load on the power system is high and the power cost is high. In addition, if the distributed power source is a power source with a lower power cost than the power system such as a solar power generation device, it is possible to contribute to the reduction of the charging cost at the charging site.

A sixteenth aspect may provide the charging planning method according to the twelfth aspect, in which in the first charging plan, the power to be received in the first time slot is downwardly corrected preferentially for a charging site provided with a distributed power source, among the plurality of charging sites, and a charging plan for at least one of the plurality of charging sites is corrected such that an amount of power to be received that has been decreased by downwardly correcting the power to be received is compensated for with power from the distributed power source provided at the charging site.

This makes it possible to decrease the power to be received in the first time slot for the charging site at which such a decrease can be compensated for with the power from the distributed power source. Thus, it is possible to meet the demand for charging of the electric vehicles. In addition, if the distributed power source is a power source with a lower power cost than the power system such as a solar power generation device, it is possible to contribute to the reduction of the charging cost at the charging site.

A seventeenth aspect may provide the charging planning method according to the thirteenth aspect, in which in the first charging plan, the power to be received in the first time slot is downwardly corrected preferentially for a charging site with a lower unit price of power to be received from the power system in a time slot different from the first time slot, among the plurality of charging sites, and a charging plan for at least one of the plurality of charging sites is corrected such that an amount of power to be received that has been decreased by downwardly correcting the power to be received is compensated for with power to be received from the power system in the different time slot.

This makes it possible to decrease the power to be received in the first time slot for the charging site at which the power cost is low in a time slot different from the first time slot. Thus, it is possible to suppress the charging cost at the charging site.

An eighteenth aspect may provide the charging planning method according to the eleventh aspect, in which in the first charging plan, the power receiving plan is corrected such that the total in the first time slot is less than or equal to the first upper limit, and when a charging plan is corrected such that an amount of power to be received that has been decreased by correcting the power receiving plan is compensated for with at least one of power from a distributed power source provided at a charging site and power to be received from the power system in a time slot different from the first time slot, charging plans for the plurality of charging sites is corrected such that an increasing charging cost at each of the plurality of charging sites is equalized among the plurality of charging sites.

This makes it possible to equalize the increasing charging cost among the plurality of sites.

A nineteenth aspect may provide the charging planning method according to the eleventh aspect, in which in the first charging plan, even when a power demand for the electric vehicles is not met as an amount of power to be received that has been decreased by correcting the power receiving plan cannot be compensated for with at least one of power from a distributed power source provided at a charging site and power to be received from the power system in a time slot different from the first time slot when the power receiving plan is corrected such that the total in the first time slot is less than or equal to the first upper limit, a charging plan for at least one of the plurality of charging sites is corrected such that the total in the first time slot is less than or equal to the first upper limit value.

This makes it possible to contribute to the stable operation of the power system. In addition, it is possible to plan charging of the electric vehicles in the range of the first upper limit value.

A twentieth aspect may provide the charging planning method according to the eleventh aspect, further including outputting an instruction to correct an operation plan for the electric vehicles when a power demand for the electric vehicles is not met as an amount of power to be received that has been decreased by correcting the power receiving plan cannot be compensated for with at least one of power from a distributed power source provided at a charging site and power to be received from the power system in a time slot different from the first time slot when the power receiving plan is corrected such that the total in the first time slot is less than or equal to the first upper limit.

This makes it possible to correct the operation plan for the electric vehicles in order for the power system to operate stably. Thus, it is possible to contribute to the stable operation of the power system.

A twenty-first aspect may provide the charging planning method according to the eleventh aspect, in which further including when a power demand for the electric vehicles is not met as an amount of power to be received that has been decreased by correcting the power receiving plan cannot be compensated for with at least one of power from a distributed power source provided at a charging site and power to be received from the power system in a time slot different from the first time slot when the power receiving plan is corrected such that the total in the first time slot is less than or equal to the first upper limit, transmitting, to the management system that manages power to be transmitted from the power system, information indicating an amount of power that could not be compensated for with at least one of the power from the distributed power source provided at the charging site and the power to be received from the power system in the time slot different from the first time slot, of the amount of the power to be received decreased by correcting the power receiving plan.

This makes it possible to notify the management system of the amount by which the demand exceeds the power to be received. Thus, it is possible to have the management system handle the excess amount.

A twenty-second aspect may provide the charging planning method according to the nineteenth aspect, in which in the first charging plan, an amount obtained by dividing an amount of power that could not be compensated for with at least one of the power from the distributed power source provided at the charging site and the power to be received from the power system in the time slot different from the first time slot, of the amount of the power to be received decreased by correcting the power receiving plan, equally by a number of the plurality of charging sites, is decreased from an amount of power to be received in the first time slot at each of the plurality of charging sites, which is planned to be received from the power system in the first time slot in the power receiving plan.

This makes it possible to equalize the amount of decrease in the power to be received among the plurality of sites. Thus, it is possible to suppress the amount of decrease in the power to be received at each charging site becoming too large.

A twenty-third aspect may provide the charging planning method according to any one of the eleventh to thirteenth and sixteenth to twenty-second aspects, in which the first time slot is a time slot in which a unit price of power to be received from the power system is lower than that in a time slot different from the first time slot.

This makes it possible to suppress the load on the power system becoming too high in a time slot in which the power cost is low.

A twenty-fourth aspect may provide the charging planning method according to any one of the thirteenth and seventeenth to twenty-third aspects, in which the upper limit includes a second upper limit value that is set for a second time slot within the predetermined period, the second upper limit value being greater than a peak value of the total of the power to be received at the plurality of charging sites in the second time slot in the power receiving plan, and the time slot different from the first time slot is the second time slot.

This makes it possible to apply the second upper limit value to the second time slot as the upper limit, the second upper limit value being greater than the peak value in the second time slot of the power receiving plan without considering the upper limit. Thus, it is possible to decrease the power to be received in the first time slot and increase the power to be received in the second time slot.

A twenty-fifth aspect may provide a charging planning device including: a controller that carries out a first charging plan for a predetermined period for each of a plurality of charging sites that are connected to a system section of a power system and that charge electric vehicles; and a storage that stores a constraint condition that makes a total of power to be received from the power system at the plurality of charging sites less than or equal to an upper limit that is less than or equal to a power capacity of system facilities, in which the controller carries out the first charging plan such that the constraint condition is met.

This makes it possible to make the total of the power to be supplied from the power system to the plurality of charging sites less than or equal to the upper limit that is less than or equal to the power capacity of the system facilities, contributing to the stable operation of the power system. In addition, the upper limit is given for the total of the power to be received from the power system at the plurality of charging sites, rather than for the power to be received from the power system at one charging site, making it possible to flexibly plan charging for the plurality of charging sites in the range of the upper limit. Thus, it is possible to achieve both stable operation of the power system and efficient charging of electric vehicles.

Furthermore, these comprehensive or specific aspects may be implemented by a system, a device, a method, an integrated circuit, a computer program, or a non-transitory computer-readable storage medium such as a compact disc read only memory (CD-ROM), or may be implemented by any combination of a system, a device, a method, an integrated circuit, a computer program, and a storage medium.

Embodiments will be described below with reference to the drawings. The embodiments to be described below each indicate a comprehensive or specific example. The numerical values, shapes, materials, constituent elements, arrangement and connection mode of the constituent elements, steps, order of the steps, etc., described in the following embodiments are exemplary, and are not intended to limit the scope of the claims.

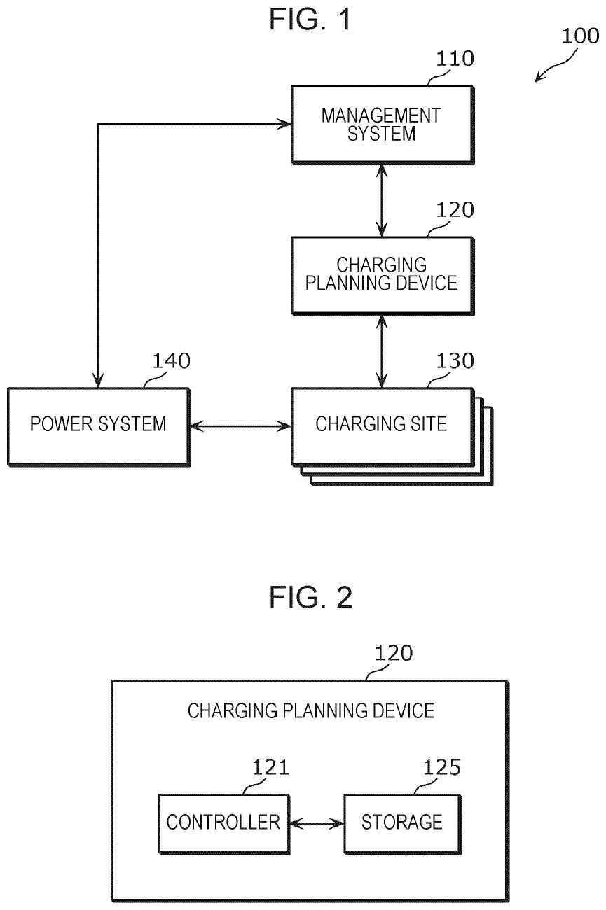

FIG. 1 is a block diagram illustrating an example of the configuration of a power control system according to an embodiment. The power control system 100 illustrated in FIG. 1 controls charging of electric vehicles. Specifically, the power control system 100 includes a management system 110 and a charging planning device 120. In addition, the power control system 100 may include a plurality of charging sites 130, and may include a power system 140. Here, the term “site” occasionally means a facility at the site.

The management system 110 is a computer, for example, and performs the role of managing the constituent elements of the power control system 100. Specifically, the management system 110 manages the power to be transmitted from the power system 140. More specifically, the management system 110 manages the power to be transmitted flowing through the power system 140 and the system facilities in the power system 140 on the basis of a power demand from a plurality of consumers such as the plurality of charging sites 130.

The management system 110 may determine a constraint condition related to the charging of a plurality of electric vehicles at the plurality of charging sites 130. The constraint condition corresponds to the upper limit of the power to be supplied from the power system 140 to the plurality of charging sites 130. The upper limit is determined to be less than or equal to the power capacity of the system facilities in the power system 140. The upper limit may be determined in accordance with the relationship between the power to be transmitted flowing through the power system 140 and the system facilities and the power capacity of the system facilities such that a power demand from a plurality of consumers such as the plurality of charging sites 130 is met.

The charging planning device 120 is a computer, for example, and performs the role of planning charging at each charging site 130. Here, “planning charging” is occasionally expressed as “making a charging plan”. Making a charging plan may include preparing an initial charging plan, and may include re-preparing a charging plan by correcting an initial charging plan.

The charging plan corresponds to a plan of charging power and charging times at charging sites 130. The charging planning device 120 plans charging such that the total of the power to be supplied from the power system 140 to the plurality of charging sites 130 is less than or equal to an upper limit provided from the management system 110.

The management system 110 and the charging planning device 120 may be integrated. Specifically, the charging planning device 120 may perform the role of the management system 110.

The charging site 130 is a charging facility that includes at least one charger, for example, and performs the role of charging electric vehicles. The “charging site 130” may be expressed as a “charging station”. One charging site 130 may include a plurality of chargers. The charging sites 130 are provided at various locations so that electric vehicles can be replenished with power on the road. The charging sites 130 may be facilities with the main purpose of charging electric vehicles, or may be facilities provided within the premises of commercial facilities such as shopping malls and convenience stores, for example near a parking area. The charging site 130 may include a distributed power source such as a solar power generation device, a power storage device, or a fuel cell device. Specifically, the charging site 130 charges electric vehicles in accordance with a charging plan made by the charging planning device 120.

When the charging site 130 includes a plurality of chargers, for example, in the charging plan, the total charging power for the plurality of chargers at the charging site 130 may be planned, rather than the charging power for each charger at the charging site 130. The total charging power may be planned such that the power from the distributed power source at the charging site 130 is allocated to the total charging power. The charging site 130 may charge a plurality of electric vehicles in accordance with the planned total charging power.

The charging site 130 may include a computer, and may plan the operation of the electric vehicles. In the charging plan, charging may be planned in accordance with an operation plan, which is a plan for the operation of the electric vehicles. The operation plan may correspond to a delivery plan.

The power system 140 is a commercial power source, for example, and performs the role of generating, transforming, transmitting, and distributing power. The system facilities in the power system 140 include a power transformation facility, a power distribution network, etc., and have a power capacity. When the plurality of charging sites 130 receive power from the power system 140, the system facilities in the power system 140 are shared by the plurality of charging sites 130.

FIG. 2 is a block diagram illustrating an example of the configuration of the charging planning device 120 illustrated in FIG. 1. The charging planning device 120 illustrated in FIG. 2 includes a controller 121 and a storage 125.

The controller 121 is a circuit, for example, and performs the role of performing information processing such as information input processing, output processing, and arithmetic processing. The controller 121 may be a processor such as a central processing unit (CPU) or a microprocessing unit (MPU), or may be composed of a plurality of circuit elements. Operation of the charging planning device 120 is basically carried out by the controller 121. For example, the controller 121 plans charging at each charging site 130 so as to meet a constraint condition for making the total of the power to be supplied from the power system 140 to the plurality of charging sites 130 less than or equal to the upper limit.

The controller 121 may acquire information for planning charging at each charging site 130. The controller 121 may receive information input via an input interface, or may receive information via a communication interface. The controller 121 may plan charging at each charging site 130. The controller 121 may output a charging plan at each charging site 130 as information. The controller 121 may output information via an output interface, or may transmit information via a communication interface.

The storage 125 is a memory, for example, and performs the role of storing information. The storage 125 may be a circuit. The storage 125 may be a volatile memory, or may be a non-volatile memory. The storage 125 may be composed of a plurality of memory elements. The storage 125 may store the constraint condition, and may store the upper limit.

The charging planning device 120 plans charging at each charging site 130 in accordance with the plurality of constituent elements described above. FIG. 2 illustrates an example of the configuration of the charging planning device 120, and the configuration of the charging planning device 120 is not limited to the example illustrated in FIG. 2.

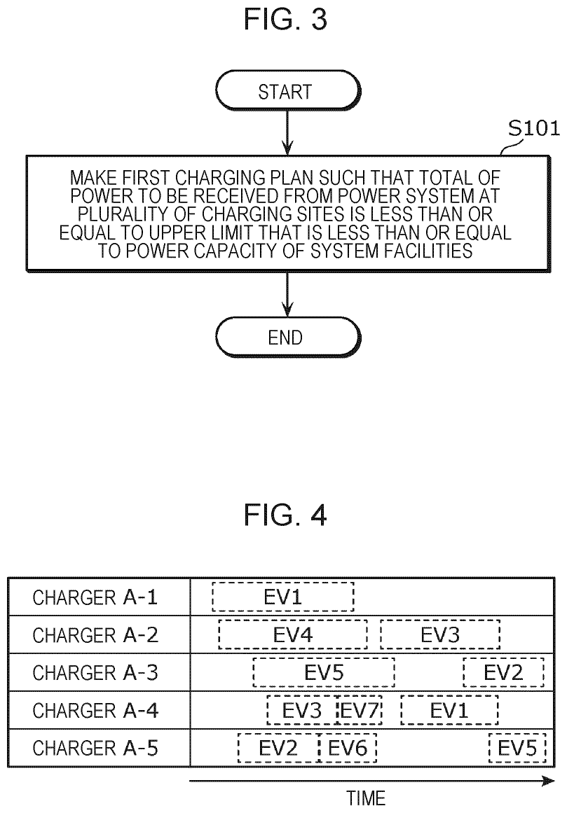

FIG. 3 is a flowchart illustrating an example of operation of the charging planning device 120 illustrated in FIG. 1, etc. Specifically, the charging planning device 120 makes a first charging plan for a predetermined period for each charging site 130 such that the total of the power to be received from the power system 140 at the plurality of charging sites 130 is less than or equal to the upper limit which is less than or equal to the power capacity of the system facilities (S101).

This makes it possible to make the total of the power to be supplied from the power system 140 to the plurality of charging sites 130 less than or equal to the upper limit that is less than or equal to the power capacity of the system facilities, contributing to the stable operation of the power system 140. In addition, the upper limit is given for the total of the power to be received from the power system 140 at the plurality of charging sites 130, rather than for the power to be received from the power system 140 at one charging site 130, making it possible to flexibly plan charging for the plurality of charging sites 130 in the range of the upper limit.

Thus, it is possible to achieve both stable operation of the power system 140 and efficient charging of electric vehicles.

Here, the predetermined period is a period covered by a charging plan, and may be a day, a week, or a month, for example.

For example, the upper limit may be provided for each time slot within the predetermined period. This makes it possible to change the upper limit of the total of the power to be supplied from the power system 140 to the plurality of charging sites 130 for each time slot. Thus, it is possible to flexibly plan charging in the range of the upper limit adaptively determined for the status of the power system 140 or the status of the power demand in each time slot.

In the first charging plan, for example, the charging planning device 120 may plan charging of the electric vehicles such that the ratio of the power to be received from the power system 140 to charging power is greater in a low-cost time slot than in a high-cost time slot. Here, the charging power is the charging power of at least one charger provided at the charging site 130. The high-cost time slot is a time slot with a higher unit power price, among a plurality of time slots with different unit power prices, and the low-cost time slot is a time slot with a lower unit power price, among a plurality of time slots with different unit power prices. The plurality of time slots with different unit power prices are, for example, two time slots with different unit power prices.

Consequently, for the first charging plan, it is possible to plan charging such that more power is supplied from the power system 140 to the charging site 130 in a time slot in which the load on the power system 140 is low and the power cost is low. Thus, it is possible to contribute to the stable operation of the power system 140. In addition, it is possible to contribute to the reduction of the charging cost at the charging site 130 at which charging takes place.

In the first charging plan, for example, the charging planning device 120 may plan charging of the electric vehicles such that the ratio of the power to be received from the distributed power source provided at the charging site 130 to charging power is greater in a high-cost time slot than in a low-cost time slot. Here, the charging power is the charging power of at least one charger provided at the charging site 130. The high-cost time slot is a time slot with a higher unit power price, among a plurality of time slots with different unit power prices, and the low-cost time slot is a time slot with a lower unit power price, among a plurality of time slots with different unit power prices. The plurality of time slots with different unit power prices are, for example, two time slots with different unit power prices.

Consequently, for the first charging plan, it is possible to plan charging such that more power is supplied from the distributed power source in a time slot in which the load on the power system 140 is high and the power cost is high. In addition, if the distributed power source is a power source with a lower power cost than the power system 140 such as a solar power generation device, it is possible to contribute to the reduction of the charging cost at the charging site 130.

For example, the charging planning device 120 may acquire an operation plan for the electric vehicles. The charging planning device 120 may carry out the first charging plan such that the power demand for the electric vehicles is met in a time slot in which the electric vehicles are chargeable and which is set on the basis of the operation plan for the electric vehicles. This makes it possible to plan charging of the electric vehicles in an appropriate time slot on the basis of the operation plan for the electric vehicles. Thus, it is possible to operate the electric vehicles on the basis of the operation plan.

For example, the charging planning device 120 may determine the charger to charge the electric vehicles on the basis of the time slot in which the electric vehicles are chargeable. This makes it possible to adaptively allocate the charger to the electric vehicles. Thus, it is possible to plan charging more flexibly.

For example, the charging planning device 120 may receive information indicating the above upper limit from the management system 110, which manages the power to be transmitted from the power system 140. This makes it possible to acquire, from the management system 110, an appropriate upper limit for the total of the power to be received from the power system 140 at the plurality of charging sites 130. Thus, it is possible to plan charging in accordance with the appropriate upper limit acquired from the management system 110.

Here, the information indicating the upper limit may be information directly indicating the upper limit, or may be information indirectly indicating the upper limit. Specifically, the information indicating the upper limit may directly indicate the upper limit with an upper limit power value, such as “3000 kW@1 PM”. Alternatively, the information indicating the upper limit may indirectly indicate the upper limit with a difference from the power demand, such as “−300 kW@1 PM”. This power demand may correspond to the peak value of the total of the power to be received from the power system 140 at the plurality of charging sites 130 in the relevant time slot. “3000 kW@1 PM” indicates that the upper limit at 1:00 p.m. is 3000 kW. Meanwhile, “−300 kW@1 PM” indicates that the upper limit at 1:00 p.m. is-300 kW relative to the power demand.

In addition, for example, the charging planning device 120 may carry out a second charging plan such that the power demand for the electric vehicles for the predetermined period is met for each charging site 130 without considering the upper limit. In the second charging plan, the charging planning device 120 may plan first power to be received from the power system 140, which is included in the charging power for the electric vehicles.

The charging planning device 120 may transmit a power receiving plan to the management system 110, the power receiving plan being a plan for the power to be received from the power system 140, including the first power to be received, at each charging site 130.

The upper limit may be determined by the management system 110 on the basis of the power receiving plan received by the management system 110.

This makes it possible to plan charging in the range of the upper limit determined by the management system 110 on the basis of the power demand without considering the upper limit. Thus, it is possible to plan charging in the range of the upper limit that reflects the original power demand.

The first power to be received may be power to be received to charge the electric vehicles. The power to be received from the power system 140, including the first power to be received, may be the total of the first power to be received and power to be received at the charging site 130 other than the first power to be received. The power to be received at the charging site 130 other than the first power to be received may include power to be consumed by a building, a power storage battery, etc., of the charging site 130.

In addition, for example, the charging planning device 120 may carry out a second charging plan such that the power demand for the electric vehicles for the predetermined period is met for each charging site 130 without considering the upper limit. In the second charging plan, the charging planning device 120 may plan first power to be received from the power system 140, which is included in the charging power for the electric vehicles. The charging planning device 120 may determine the upper limit on the basis of a power receiving plan, which is a plan for the power to be received from the power system 140, including the first power to be received, at each charging site 130.

This makes it possible to determine the upper limit on the basis of the power demand without considering the upper limit. Thus, it is possible to reflect the original power demand in the upper limit.

For example, the charging planning device 120 may determine the upper limit on the basis of the power capacity of the system facilities and the power to be transmitted from the power system 140. This makes it possible to plan charging in the range of the upper limit which is based on the power capacity of the system facilities and the power to be transmitted from the power system 140. Thus, it is possible to contribute to the stable operation of the power system 140.

For example, the above upper limit may include a first upper limit value that is set for a first time slot within the predetermined period, the first upper limit value being less than the peak value of the total of the power to be received from the power system 140 at the plurality of charging sites 130 in the first time slot. This makes it possible to apply the first upper limit value to the first time slot as the upper limit, the first upper limit value being less than the peak value in the first time slot of the power receiving plan without considering the upper limit. Thus, the power to be received in the first time slot is suppressed, making it possible to contribute to the stable operation of the power system.

For example, in the first charging plan, the charging planning device 120 may correct the power receiving plan such that the total of the power to be received in the first time slot above is less than or equal to the first upper limit value. In the first charging plan, the charging planning device 120 may correct the charging plan for at least one charging site 130 such that at least a part of the amount of the power to be received that has been decreased by correcting the power receiving plan is compensated for with the power from the distributed power source provided at the charging site 130.

This makes it possible to compensate for the amount of decrease in the power to be received in the first time slot with the power from the distributed power source. Thus, it is possible to meet the demand for charging of the electric vehicles. In addition, if the distributed power source is a power source with a lower power cost than the power system 140 such as a solar power generation device, it is possible to contribute to the reduction of the charging cost at the charging site 130.

The charging planning device 120 may compensate for at least a part of the amount of the power to be received that has been decreased by correcting the power receiving plan with the power from the distributed power source in the first time slot, or with the power from the distributed power source in a time slot different from the first time slot.

For example, in the first charging plan, the charging planning device 120 may correct the power receiving plan such that the total of the power to be received in the first time slot above is less than or equal to the first upper limit value. In the first charging plan, the charging planning device 120 may correct the charging plan for at least one charging site 130 such that at least a part of the amount of the power to be received that has been decreased by correcting the power receiving plan is compensated for with the power to be received from the power system 140 in a time slot different from the first time slot.

This makes it possible to compensate for the amount of decrease in the power to be received in the first time slot with the power to be received in a different time slot. Thus, it is possible to meet the demand for charging of the electric vehicles.

For example, in the second charging plan, the charging planning device 120 may plan charging of the electric vehicles such that the ratio of the power to be received from the power system 140 to charging power is greater in a low-cost time slot than in a high-cost time slot. Here, the charging power is the charging power of at least one charger provided at the charging site 130. The high-cost time slot is a time slot with a higher unit power price, among a plurality of time slots with different unit power prices, and the low-cost time slot is a time slot with a lower unit power price, among a plurality of time slots with different unit power prices. The plurality of time slots with different unit power prices are, for example, two time slots with different unit power prices.

Consequently, for the second charging plan, it is possible to plan charging such that more power is supplied from the power system 140 to the charging site 130 in a time slot in which the load on the power system 140 is low and the power cost is low. Thus, it is possible to contribute to the stable operation of the power system 140. In addition, it is possible to contribute to the reduction of the charging cost at the charging site 130.

In the second charging plan, for example, the charging planning device 120 may plan charging of the electric vehicles such that the ratio of the power to be received from the distributed power source provided at the charging site 130 to charging power is greater in a high-cost time slot than in a low-cost time slot. Here, the charging power is the charging power of at least one charger provided at the charging site 130. The high-cost time slot is a time slot with a higher unit power price, among a plurality of time slots with different unit power prices, and the low-cost time slot is a time slot with a lower unit power price, among a plurality of time slots with different unit power prices. The plurality of time slots with different unit power prices are, for example, two time slots with different unit power prices.

Consequently, for the second charging plan, it is possible to plan charging such that more power is supplied from the distributed power source in a time slot in which the load on the power system 140 is high and the power cost is high. In addition, if the distributed power source is a power source with a lower power cost than the power system 140 such as a solar power generation device, it is possible to contribute to the reduction of the charging cost at the charging site 130.

For example, in the first charging plan, the charging planning device 120 may downwardly correct the power to be received in the first time slot preferentially for a charging site 130 provided with a distributed power source, among the plurality of charging sites 130. In the first charging plan, the charging planning device 120 may correct the charging plan for at least one charging site 130 such that the amount of the power to be received that has been decreased by downwardly correcting the power to be received is compensated for with the power from the distributed power source provided at the charging site 130.

This makes it possible to decrease the power to be received in the first time slot for the charging site 130 at which such a decrease can be compensated for with the power from the distributed power source. Thus, it is possible to meet the demand for charging of the electric vehicles. In addition, if the distributed power source is a power source with a lower power cost than the power system 140 such as a solar power generation device, it is possible to contribute to the reduction of the charging cost at the charging site 130.

Here, also in the second charging plan, the distributed power source may be a distributed power source having surplus power relative to the power demand. That is, the charging planning device 120 may downwardly correct the power to be received in the first time slot preferentially for a charging site 130 provided with a distributed power source having surplus power relative to the power demand.

For example, in the first charging plan, the charging planning device 120 may downwardly correct the power to be received in the first time slot preferentially for a charging site 130 with a lower unit price of the power to be received from the power system 140 in a time slot different from the first time slot, among the plurality of charging sites 130. In the first charging plan, the charging planning device 120 may correct the charging plan for at least one charging site 130 such that the amount of the power to be received that has been decreased by downwardly correcting the power to be received is compensated for with the power to be received from the power system 140 in a time slot different from the first time slot.

This makes it possible to decrease the power to be received in the first time slot for the charging site 130 at which the power cost is low in a time slot different from the first time slot. Thus, it is possible to suppress the charging cost at the charging site 130.

For example, in the first charging plan, the charging planning device 120 may correct the power receiving plan such that the total of the power to be received in the first time slot above is less than or equal to the first upper limit value.

In the first charging plan, the charging planning device 120 may correct the charging plan for the charging site 130 such that the amount of the power to be received that has been decreased by correcting the power receiving plan is compensated for with at least one of the power from the distributed power source or the power to be received from the power system 140 in a different time slot. Here, the distributed power source is a distributed power source provided at the charging site 130. The different time slot is a time slot different from the first time slot.

I the first charging plan, when correcting the charging plan, the charging planning device 120 may correct the charging plan for the plurality of charging sites 130 such that an increasing charging cost at each charging site 130 is equalized among the plurality of charging sites 130.

This makes it possible to equalize the increasing charging cost among the plurality of charging sites 130. Thus, it is possible to suppress deviation in the load on the power system 140.

For example, in the first charging plan, the charging planning device 120 may correct the power receiving plan such that the total of the power to be received in the first time slot above is less than or equal to the first upper limit value. In this case, it may not be possible to compensate for the amount of the power to be received that has been decreased by correcting the power receiving plan with at least one of the power from the distributed power source provided at the charging site 130 or the power to be received from the power system 140 in a time slot different from the first time slot. In this case, the power demand for the electric vehicles may not be met.

Even when the power demand for the electric vehicles is not met as described above, in the first charging plan, the charging planning device 120 may correct the charging plan for at least one charging site 130 such that the total of the power to be received in the first time slot above is less than or equal to the first upper limit value.

This makes it possible to contribute to the stable operation of the power system 140. In addition, it is possible to plan charging of the electric vehicles in the range of the first upper limit value.

For example, the charging planning device 120 may correct the power receiving plan such that the total of the power to be received in the first time slot above is less than or equal to the first upper limit value. In this case, it may not be possible to compensate for the amount of the power to be received that has been decreased by correcting the power receiving plan with at least one of the power from the distributed power source provided at the charging site 130 and the power to be received from the power system 140 in a time slot different from the first time slot. In this case, the power demand for the electric vehicles may not be met.

When the power demand for the electric vehicles is not met as described above, the charging planning device 120 may output an instruction to correct the operation plan for the electric vehicles.

This makes it possible to correct the operation plan for the electric vehicles in order for the power system 140 to operate stably. Thus, it is possible to contribute to the stable operation of the power system 140.

For example, in the first charging plan, the charging planning device 120 may correct the power receiving plan such that the total of the power to be received in the first time slot above is less than or equal to the first upper limit value. In this case, it may not be possible to compensate for the amount of the power to be received that has been decreased by correcting the power receiving plan with at least one of the power from the distributed power source provided at the charging site 130 and the power to be received from the power system 140 in a time slot different from the first time slot. In this case, the power demand for the electric vehicles may not be met.

When the power demand for the electric vehicles is not met as described above, the charging planning device 120 may transmit, to the management system 110 which manages the power to be transmitted from the power system 140, information indicating the amount of power that could not be compensated for, of the amount of the power to be received decreased by correcting the power receiving plan. Here, the amount of power that could not be compensated for is the amount of power that could not be compensated for with at least one of the power from the distributed power source provided at the charging site 130 or the power to be received from the power system 140 in a time slot different from the first time slot.

This makes it possible to notify the management system 110 of the amount by which the demand exceeds the power to be received. Thus, it is possible to have the management system 110 handle the excess amount.

For example, in the first charging plan, the charging planning device 120 may correct the power receiving plan such that the total of the power to be received in the first time slot above is less than or equal to the first upper limit value.

In that event, the charging planning device 120 may decrease an amount obtained by dividing the amount of the power to be received decreased by the correction equally by the number of the plurality of charging sites 130, from the amount of the power to be received at each charging site 130 in the first time slot, which is planned be received from the power system 140 in the first time slot in the power receiving plan. Here, the amount of the power to be received decreased by the correction is the amount of the power to be received decreased by correcting the power receiving plan for the entirety of the plurality of charging sites 130.

This makes it possible to equalize the amount of decrease in the power to be received among the plurality of charging sites 130. Thus, it is possible to suppress the amount of decrease in the power to be received at each charging site 130 becoming too large.

For example, in the first charging plan, the charging planning device 120 may decrease an amount obtained by dividing the amount of power that could not be compensated for, of the amount of the power to be received decreased by the correction, equally by the number of the plurality of charging sites 130, from the amount of the power to be received at each charging site 130 in the first time slot.

Here, the amount of the power to be received at each charging site 130 in the first time slot is the amount of the power to be received, which is planned to be received from the power system 140 in the first time slot in the power receiving plan. The correction is the correction of the power receiving plan. The amount of power that could not be compensated for is the amount of power that could not be compensated for with at least one of the power from the distributed power source provided at the charging site 130 or the power to be received from the power system 140 in a time slot different from the first time slot.

This makes it possible to equalize the amount of decrease in the power to be received among the plurality of charging sites 130. Thus, it is possible to suppress the amount of decrease in the power to be received at each charging site 130 becoming too large.

For example, the first time slot may be a time slot with a lower unit price of the power to be received from the power system 140 than that in a time slot different from the first time slot. This makes it possible to suppress the load on the power system becoming too high in a time slot in which the power cost is low.

For example, the upper limit may include a second upper limit value that is set for a second time slot within the predetermined period, the second upper limit value being greater than the peak value of the total of the power to be received at the plurality of charging sites 130 in the second time slot of the power receiving plan. The time slot different from the first time slot may be the second time slot.

This makes it possible to apply the second upper limit value to the second time slot as the upper limit, the second upper limit value being greater than the peak value in the second time slot of the power receiving plan without considering the upper limit. Thus, it is possible to decrease the power to be received in the first time slot and increase the power to be received in the second time slot.

In the above description, the amount of the power to be received that has been decreased by correcting the power receiving plan corresponds to the amount of decrease in the amount of power to be received. That is, the amount of the power to be received that has been decreased by correcting the power receiving plan corresponds to the difference between the amount of power to be received before the decrease and the amount of power to be received after the decrease. Similarly, the amount of the power to be received that has been decreased by downwardly correcting the power to be received corresponds to the amount of decrease in the amount of power to be received. That is, the amount of the power to be received that has been decreased by downwardly correcting the power to be received corresponds to the difference between the amount of power to be received before the decrease and the amount of power to be received after the decrease.

More specific examples of the charging planning device and the charging planning method will be described below. The configuration and the operation described in the following more specific examples may optionally be applied to the charging planning device and the charging planning method.

FIG. 4 is a conceptual diagram illustrating a first specific example of time slots in which electric vehicles are chargeable based on an operation plan. The operation plan may be a delivery plan. For example, a plurality of electric vehicles (EV1 to EV7) operate along a route that starts and ends at a charging site (A). The plurality of electric vehicles (EV1 to EV7) are charged using chargers (A-1 to A-5) while the plurality of electric vehicles (EV1 to EV7) are staying at the charging site (A).

Thus, the time slots in which the electric vehicles (EV1 to EV7) are chargeable correspond to time slots in which the electric vehicles (EV1 to EV7) are staying at the charging site (A). The time slots in which the electric vehicles (EV1 to EV7) are chargeable may be determined on condition that the chargers (A-1 to A-5) can be allocated. FIG. 4 illustrates a specific example of such time slots.

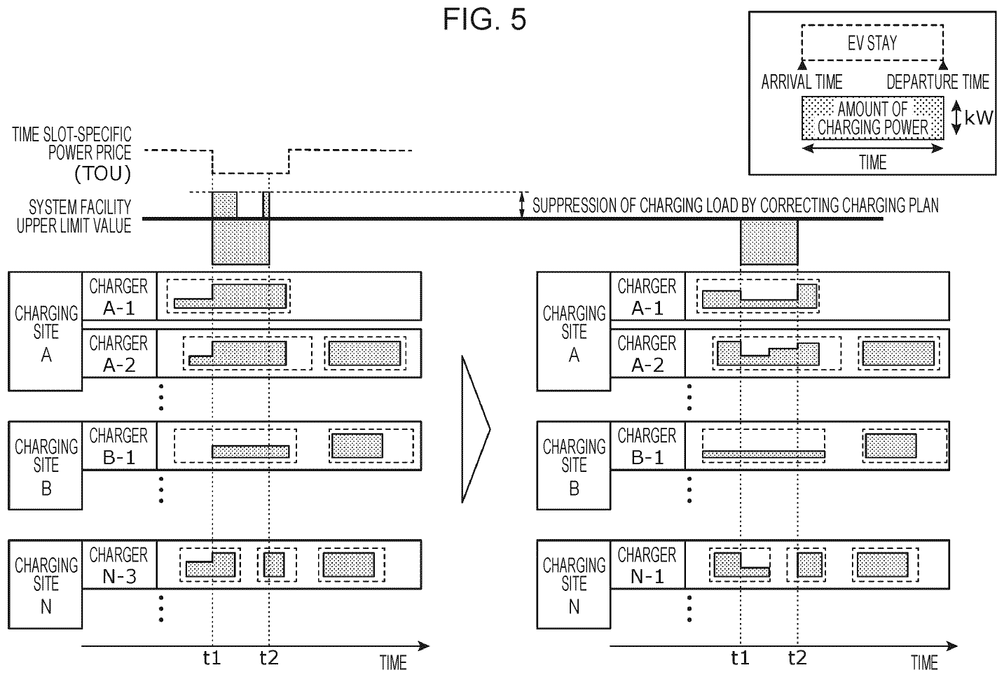

FIG. 5 is a conceptual diagram illustrating a first specific example of a charging plan corresponding to the presence or absence of control based on an upper limit value. In FIG. 5, the dotted rectangles indicate time slots in which electric vehicles are chargeable, and time slots in which electric vehicles are staying at the charging site. The hatched areas correspond to the amount of charging power. FIG. 5 also indicates a time slot-specific unit power price. The time slot-specific unit power price is also expressed as a “Time Of Use (TOU)”. In the example in FIG. 5, charging is planned in accordance with the chargeable time slots determined as in FIG. 4.

For example, a time slot from t1 to t2 is included in a time slot with a low time slot-specific unit power price. Therefore, the total power demand for a group of charging sites (A, B, and N) is high in this time slot. It is expected that the total power demand will exceed the upper limit value of the power capacity of the system facilities in this time slot, which may interfere with the stable operation of the power system (left side of FIG. 5). As a result, power may not be supplied from the power system, which may interfere with the operation of the electric vehicles.

Thus, the charging plan is corrected such that the total power demand for the group of charging sites (A, B, and N) does not exceed the upper limit value of the power capacity of the system facilities in this time slot (right side of FIG. 5). For example, charging power and charging times for the electric vehicles are adjusted in the time slot in which the electric vehicles are chargeable based on the operation plan. This makes it possible to operate the electric vehicles on the basis of the operation plan, contributing to the stable operation of the power system.

FIG. 5 illustrates an example of a case where the charging sites do not include a solar power generation device, a power storage device, a building, etc., but only the chargers. Thus, the charging plan in the example in FIG. 5 corresponds to the plan for the “first power to be received” according to the present disclosure.

When the charging sites include a distributed power source such as a solar power generation device, a power storage device, or a fuel cell device, the distributed power source may be taken into consideration when correcting the charging plan. The charging power may be controlled by correcting the charging plan such that the charging cost at the charging sites is minimized. The charging amount corresponds to the amount of charging power. The amount of charging power is occasionally expressed simply as “charging power”.

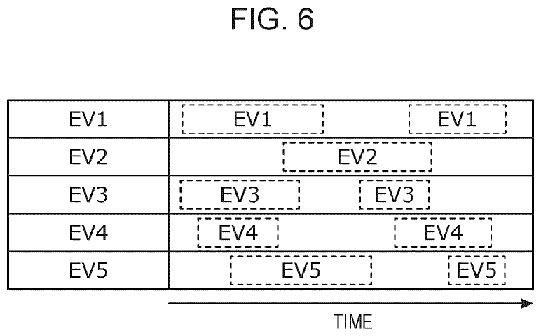

FIG. 6 is a conceptual diagram illustrating a second specific example of time slots in which electric vehicles are chargeable based on an operation plan. In the example in FIG. 6, as in the example in FIG. 4, time slots in which electric vehicles (EV1 to EV5) are staying at a charging site (A) on the basis of the operation plan are indicated as time slots in which the electric vehicles (EV1 to EV5) are chargeable. On the other hand, in the example in FIG. 6, compared to the example in FIG. 4, no chargers are allocated to the electric vehicles (EV1 to EV5). The chargers to charge the electric vehicles (EV1 to EV5) are determined when planning charging.

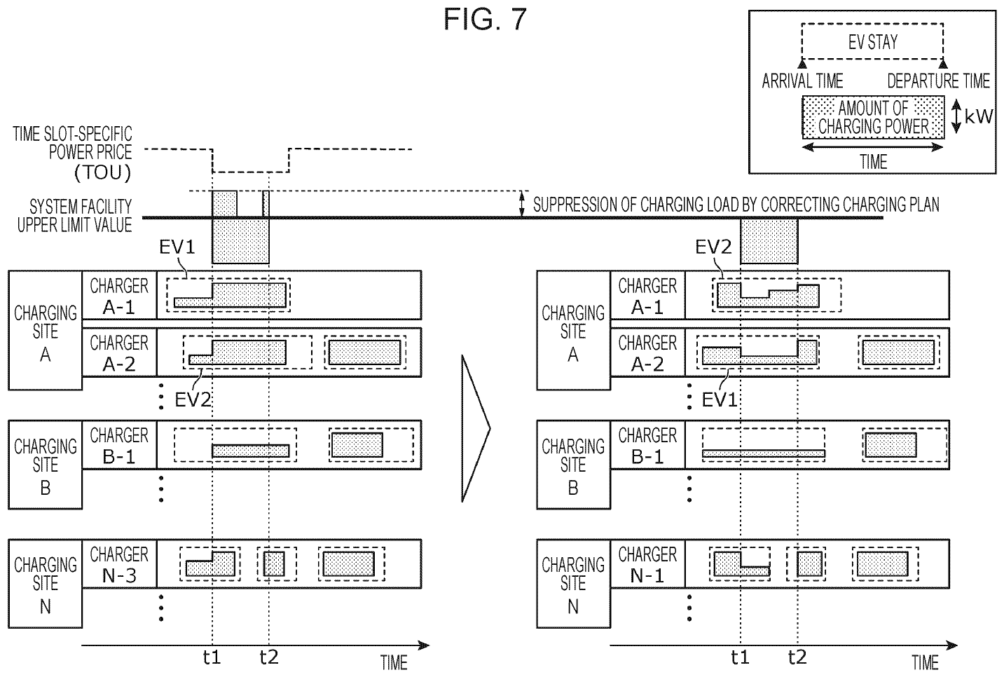

FIG. 7 is a conceptual diagram illustrating a second specific example of a charging plan corresponding to the presence or absence of control based on an upper limit value. In the example in FIG. 7, charging is planned as in the example in FIG. 5. However, in the example in FIG. 7, compared to the example in FIG. 5, charging is planned in accordance with the chargeable time slots determined as in FIG. 6. That is, charging is planned in accordance with the chargeable time slots in which no chargers are allocated. The chargers to charge the electric vehicles are determined when charging is planned.

Specifically, in the example in FIG. 7, as in the example in FIG. 5, the charging plan is corrected such that the total power demand for the group of charging sites (A, B, and N) does not exceed the upper limit value of the power capacity of the system facilities (right side of FIG. 7). In that event, the charger used to charge EV1 is changed from A-1 to A-2. In addition, the charger used to charge EV2 is changed from A-2 to A-1.

For example, in the charging plan, a charger may be selected from among a plurality of chargers with different rated capacities. This allows the electric vehicles to be charged efficiently in the chargeable time slots.

FIG. 7 illustrates an example of a case where the charging sites do not include a solar power generation device, a power storage device, a building, etc., but only the chargers. Thus, the charging plan in the example in FIG. 7 corresponds to the plan for the “first power to be received” according to the present disclosure.

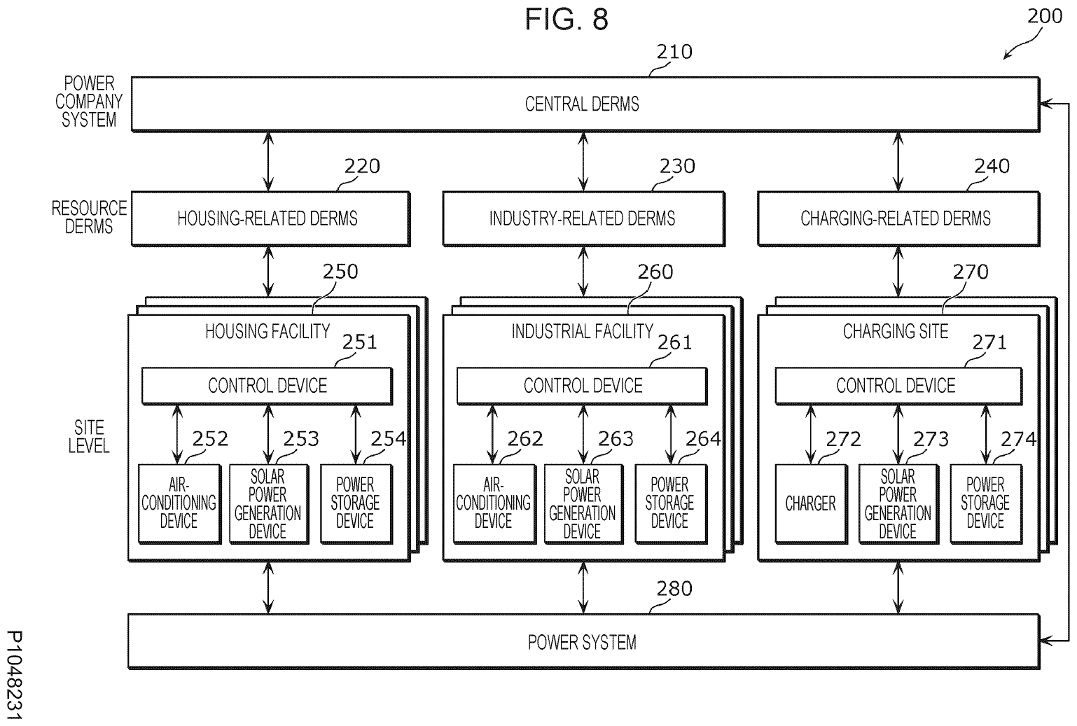

FIG. 8 is a block diagram illustrating a specific example of the configuration of a power control system according to an embodiment. A power control system 200 illustrated in FIG. 8 includes a central Distributed Energy Resource Management System (DERMS) 210. The power control system 200 further includes a housing-related DERMS 220, an industry-related DERMS 230, a charging-related DERMS 240, a plurality of housing facilities 250, a plurality of industrial facilities 260, a plurality of charging sites 270, an a power system 280.

The central DERMS 210 is a computer, for example, corresponds to the management system 110 illustrated in FIG. 1, and performs the same role as the management system 110. For example, the central DERMS 210 is a system of a power company, and manages the power to be transmitted flowing through the power system 280 and system facilities in the power system 280. The central DERMS 210 may adjust the power to be transmitted in cooperation with a plurality of resource DERMS such as the housing-related DERMS 220, the industry-related DERMS 230, and the charging-related DERMS 240.

The housing-related DERMS 220 is a computer, for example, and manages power generation and power consumption at the plurality of housing facilities 250. Specifically, the housing-related DERMS 220 may acquire information indicating the state of the power system 280 from the central DERMS 210. The housing-related DERMS 220 may transmit, to the housing facilities 250, information for controlling operation of the housing facilities 250 in accordance with the state of the power system 280.

Here, the state of the power system 280 may be the state of the power to be supplied from the power system 280. Examples of the state of the power to be supplied from the power system 280 include current, voltage, and power states of the power system 280. The state of the power system 280 may be the state of the power supply and demand of the power system 280. The information for controlling operation may be a command to control operation.

The industry-related DERMS 230 is a computer, for example, and manages power generation and power consumption at the plurality of industrial facilities 260. Specifically, the industry-related DERMS 230 may acquire information indicating the state of the power system 280 from the central DERMS 210. The industry-related DERMS 230 may transmit, to the industrial facilities 260, information for controlling operation of the industrial facilities 260 in accordance with the state of the power system 280.

The charging-related DERMS 240 is a computer, for example, corresponds to the charging planning device 120 illustrated in FIG. 1, and performs the same role as the charging planning device 120. For example, the charging-related DERMS 240 receives, from the central DERMS 210, information indicating a constraint condition for making the power to be supplied from the power system 280 to the plurality of charging sites 270 less than or equal to an upper limit. Here, the upper limit is determined to be less than or equal to the power capacity of the system facilities in the power system 280. The information indicating the constraint condition may be information indicating the upper limit.

The charging-related DERMS 240 plans charging such that the constraint condition is met. That is, the charging-related DERMS 240 plans charging such that the total of the power to be supplied from the power system 280 to the plurality of charging sites 270 is less than or equal to the upper limit.

The housing facilities 250 are facilities in a human living space, and include an air-conditioning device 252, a solar power generation device 253, and a power storage device 254, for example. The housing facilities 250 may further include a fuel cell device, etc. Operation of the constituent elements of the housing facilities 250 may be controlled in accordance with the information transmitted from the housing-related DERMS 220 to the housing facilities 250. The housing facilities 250 may include a control device 251 that controls operation of the constituent elements of the housing facilities 250 in accordance with the information transmitted from the housing-related DERMS 220 to the housing facilities 250.

The industrial facilities 260 are facilities in a factory or an institution, and include an air-conditioning device 262, a solar power generation device 263, and a power storage device 264, for example. The industrial facilities 260 may further include a fuel cell device, etc. Operation of the constituent elements of the industrial facilities 260 may be controlled in accordance with the information transmitted from the industry-related DERMS 230 to the industrial facilities 260. The industrial facilities 260 may include a control device 261 that controls operation of the constituent elements of the industrial facilities 260 in accordance with the information transmitted from the industry-related DERMS 230 to the industrial facilities 260.

The charging sites 270 are charging facilities including a charger 272, a solar power generation device 273, and a power storage device 274, for example, corresponds to the charging sites 130 illustrated in FIG. 1, and performs the same role as the charging sites 130. The charging sites 270 may include a plurality of chargers 272. The charging sites 270 may include a fuel cell device.

Operation of the constituent elements of the charging sites 270 may be controlled in accordance with the information transmitted from the charging-related DERMS 240 to the charging sites 270. The charging sites 270 may include a control device 271 that controls operation of the constituent elements of the charging sites 270 in accordance with the information transmitted from the charging-related DERMS 240 to the charging sites 270.

At the charging sites 270, electric vehicles may be charged in accordance with a charging plan made by the charging-related DERMS 240.

The power system 280 is a commercial power source, for example, corresponds to the power system 140 illustrated in FIG. 1, and performs the same role as the power system 140. In the example in FIG. 8, the power system 280 supplies power to the plurality of housing facilities 250, the plurality of industrial facilities 260, and the plurality of charging sites 270.

The charging planning device 120 in FIG. 1 mainly corresponds to the charging-related DERMS 240, but may correspond to both the central DERMS 210 and the charging-related DERMS 240. That is, the charging planning device 120 in FIG. 1 may include the central DERMS 210 and the charging-related DERMS 240.

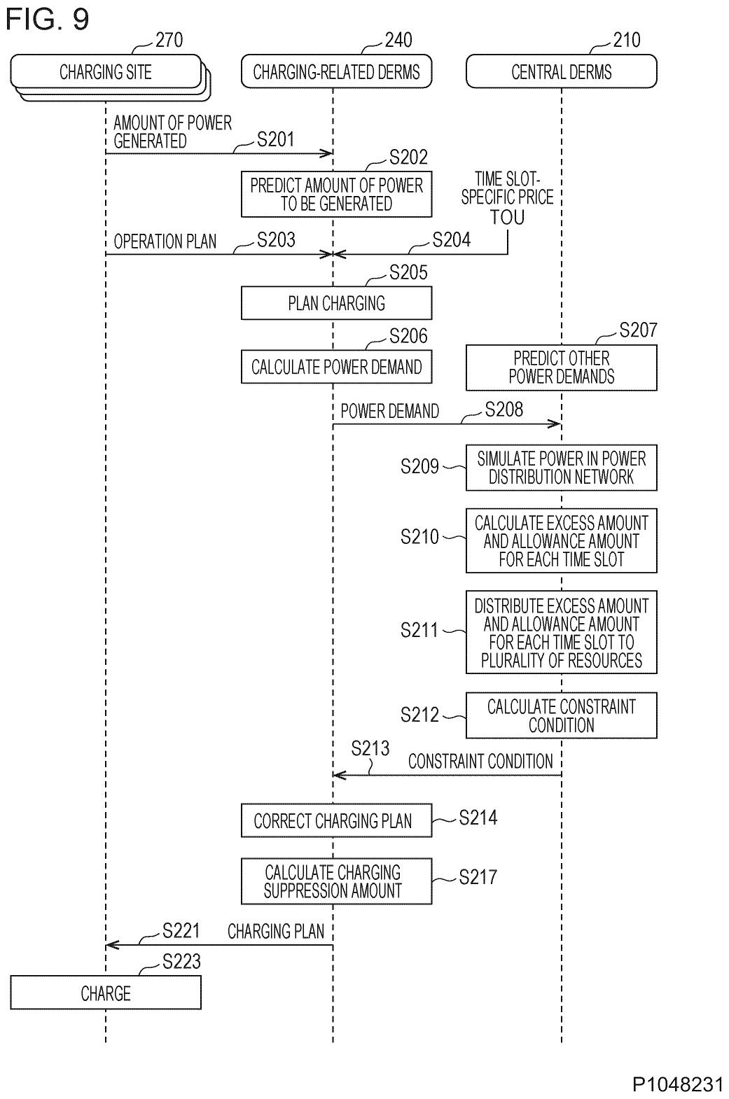

FIG. 9 is a sequence diagram illustrating a first specific example of operation of the power control system 200 illustrated in FIG. 8.

First, each charging site 270 transmits information indicating the amount of power generated by the solar power generation device 273 in the past to the charging-related DERMS 240, and the charging-related DERMS 240 receives the information indicating the amount of power generated by the solar power generation device 273 in the past from each charging site 270 (S201). Next, the charging-related DERMS 240 predicts the amount of power to be generated at each charging site 270 in the future (S202). For example, the charging-related DERMS 240 predicts the amount of power to be generated in each time slot of the following day.

Each charging site 270 transmits an operation plan to the charging-related DERMS 240, and the charging-related DERMS 240 receives the operation plan from each charging site 270 (S203). The operation plan may be transmitted from an element other than each charging site 270, and may be transmitted from a system that prepares an operation plan related to the plurality of charging sites 270, for example. Such a system may be a management system that manages electric vehicles (e.g., an operation management system of a delivery company).

The operation plan may include information about a power demand for electric vehicles. Specifically, the operation plan may include information on when and how much charging is to be performed (e.g., to increase the state of charge (SOC) from x % to y %).

The charging-related DERMS 240 acquires a time slot-specific price (TOU) from a power company (S204). The charging-related DERMS 240 may acquire a time slot-specific price from the central DERMS 210, or may retain a time slot-specific price in advance.

Furthermore, each charging site 270 may transmit information indicating the state of charge (SOC) of the power storage device 274 to the charging-related DERMS 240. The charging-related DERMS 240 may receive the information indicating the state of charge of the power storage device 274 from each charging site 270.

Next, the charging-related DERMS 240 plans charging of electric vehicles at each charging site 270 on the basis of the amount of power to be generated, the operation plan, the time slot-specific price, etc. (S205). Consequently, a charging plan for each charging plan 270 is prepared. For example, the charging-related DERMS 240 plans charging power and charging times for electric vehicles for the following day such that the charging cost is minimized. In particular, the charging-related DERMS 240 plans charging such that the electric vehicles are charged while the electric vehicles are staying at the charging site 270 in the operation plan.

The charging-related DERMS 240 may plan charging of electric vehicles at each charging site 270 further on the basis of the state of charge of the power storage device 274, in addition to the amount of power to be generated, the operation plan, and the time slot-specific price.

The proportion of the power from the power system 280, the power from the solar power generation device 273, and the power from the power storage device 274, of the power to be used for charging, may be planned. Planning may be made such that the proportion of the power from the power system 280 is high in a time slot with a low unit power price. In addition, planning may be made such that the proportion of the power from the distributed power source such as the solar power generation device 273 and the power storage device 274 is high in a time slot with a high unit power price.

Next, the charging-related DERMS 240 calculates a power demand for the power system 280 on the basis of the charging plan for each charging site 270 (S206). For example, the charging-related DERMS 240 calculates, as a power demand, power to be supplied from the power system 280 for each time slot, by excluding power to be supplied from the solar power generation device 273 and the power storage device 274 from charging power in the charging plan for each charging site 270. This power demand corresponds to the power receiving plan for the power to be received from the power system 280 at each charging site 270.

The charging-related DERMS 240 transmits information indicating the power demand to the central DERMS 210, and the central DERMS 210 receives the information indicating the power demand from the charging-related DERMS 240 (S208).

On the other hand, the central DERMS 210 predicts other power demands for each time slot (S207). The other power demands are power demands other than the power demand for charging electric vehicles. Examples of the power demands other than the power demand for charging electric vehicles include a power demand obtained from the housing-related DERMS 220, a power demand obtained from the industry-related DERMS 230, and a general power demand not connected to any DERMS.

The central DERMS 210 simulates the power in the power distribution network on the basis of all the power demands (S209). For example, the central DERMS 210 calculates power flowing through the system facilities in the power distribution network for each time slot.

Next, the central DERMS 210 calculates an excess amount and an allowance amount of the power flowing through the system facilities in the power distribution network with respect to the power capacity of the system facilities for each time slot in the simulation of the power in the power distribution network (S210).

Next, the central DERMS 210 distributes the excess amount and the allowance amount for each time slot to a plurality of resources (S211). For example, the central DERMS 210 distributes the excess amount and the allowance amount for each time slot to housing-related resources, industry-related resources, and charging-related resources. In the distribution, power to be reduced by demand response (DR) may be taken into consideration.

The central DERMS 210 calculates a constraint condition for the plurality of charging sites 270 in accordance with the results of the distribution of the excess amount and the allowance amount for each time slot (S212). For example, the constraint condition is expressed as “charging sites a+b=−300 kW@1 PM, charging sites a+b=+400 kW@2 PM, . . . , charging sites a+b+c=−500 kW@1 PM, . . . ”, etc. Here, the charging sites a, b, and c are included in the plurality of charging sites 270.

For example, “charging sites a+b=−300 kW@1 PM” indicates that the upper limit of the power that can be supplied from the power system 280 to the charging sites a and b at 1:00 p.m. is 300 kW lower than the power demand reported from the charging-related DERMS 240 to the central DERMS 210.

“Charging sites a+b=+400 kW@2 PM” indicates that the upper limit of the power that can be supplied from the power system 280 to the charging sites a and b at 2:00 p.m. is 400 kW higher than the power demand reported from the charging-related DERMS 240 to the central DERMS 210. “Charging sites a+b+c=−500 kW@1 PM” indicates that the upper limit of the power that can be supplied from the power system 280 to the charging sites a, b, and c at 1:00 p.m. is 500 kW lower than the power demand reported from the charging-related DERMS 240 to the central DERMS 210.

That is, an upper limit value that is less than the peak value of the total of the power to be received at the plurality of charging sites 270 may be set in a first time slot. An upper limit value that is greater than the peak value of the total of the power to be received at the plurality of charging sites 270 may be set in a second time slot. The first time slot may be a time slot in which the unit price of the power to be received from the power system 280 is lower than that in other time slots such as the second time slot.

Here, the constraint condition is expressed as the difference from the power demand. However, the constraint condition may be expressed as the absolute magnitude of the upper limit, rather than the difference from the power demand.

The constraint condition may be determined for all the charging sites 270. Alternatively, the constraint condition may be determined for some charging sites 270 that share common system facilities, rather than for all the charging sites 270.

A plurality of constraint conditions may be determined for the same time for one charging site 270. For example, “charging sites a+b=−300 kW@1 PM” and “charging sites a+b+c=−500 kW@1 PM” may be determined at the same time. The former is a constraint condition for system facilities related to the power demand for the charging sites a and b, and the latter is a constraint condition for system facilities related to the power demand for the charging sites a, b, and c in a wider area.

Next, the central DERMS 210 transmits information indicating the constraint condition to the charging-related DERMS 240, and the charging-related DERMS 240 receives the information indicating the constraint condition from the central DERMS 210 (S213).

After that, the charging-related DERMS 240 corrects the charging plan for each charging site 270 such that the constraint condition is met (S214). That is, the charging-related DERMS 240 may correct the charging plan on the basis of the constraint condition, in addition to the criteria in the charging plan (S205) initially made on the basis of the amount of power to be generated, the operation plan, the time slot-specific price (TOU), etc.

For example, the charging-related DERMS 240 corrects the power receiving plan and the charging plan for each charging site 270 such that the total of the power to be supplied from the power system 280 to the plurality of charging sites 270 in each time slot is less than or equal to the upper limit value determined for the time slot.

Specifically, the charging-related DERMS 240 may correct the power receiving plan and the charging plan for each charging site 270 such that the total of the power to be supplied from the power system 280 to the plurality of charging sites 270 in the first time slot is less than or equal to the upper limit value determined for the first time slot. The amount of the power to be received that has been decreased by correcting the power receiving plan and the charging plan may be compensated for with the power from the distributed power source, or may be compensated for with the power to be received in a time slot different from the first time slot.

The charging-related DERMS 240 may correct the power receiving plan and the charging plan such that the increasing charging cost at each charging site 270 is approximately the same among the plurality of charging sites 270. Alternatively, the charging-related DERMS 240 may correct the power receiving plan and the charging plan such that the total of the increasing charging costs at the plurality of charging sites 270 is minimized. Alternatively, the charging-related DERMS 240 may correct the power receiving plan and the charging plan in accordance with the order of priority determined among the plurality of charging sites 270.

Specifically, the power to be received at a charging site 270 provided with a distributed power source may be downwardly corrected preferentially. When the power to be received in the first time slot is downwardly corrected, the power to be received at a charging site 270 with a lower unit price of the power to be received in a time slot different from the first time slot may be downwardly corrected preferentially.

In the above correction, the charging-related DERMS 240 may correct the power receiving plan and the charging plan such that the total charging amount in the charging plan for each charging site 270 is maintained. That is, the charging-related DERMS 240 may correct the power receiving plan and the charging plan such that the power demand for the electric vehicles at each charging site 270 is met.

However, if the power demand for the electric vehicles is not met when the charging-related DERMS 240 corrects the charging plan such that the constraint condition is met, the charging-related DERMS 240 corrects the charging plan such that the constraint condition is met by suppressing the charging power, even if the power demand for the electric vehicles is not met. At this time, an amount of power that could not be compensated for with the power from the distributed power source or the power to be received in a time slot different from the first time slot, of the amount of the power to be received decreased by correcting the power receiving plan such that the total of the power to be supplied to the plurality of charging sites 270 is less than or equal to the upper limit for the first time slot, may be calculated as a charging suppression amount (S217).

The charging-related DERMS 240 may correct the power receiving plan and the charging plan such that approximately the same disadvantage is caused at the plurality of charging sites 270. Here, the disadvantage may be the charging suppression amount. Alternatively, the charging-related DERMS 240 may correct the power receiving plan and the charging plan such that the total of the disadvantages caused at the plurality of charging sites 270 is minimized. Alternatively, the charging-related DERMS 240 may correct the power receiving plan and the charging plan such that the disadvantages are allocated in accordance with the order of priority determined among the plurality of charging sites 270.

After that, the charging-related DERMS 240 transmits the charging plan to each charging site 270, and each charging site 270 receives the charging plan (S221). Each charging site 270 charges the electric vehicles in accordance with the charging plan (S223).

For example, the control device 271 at each charging site 270 may receive the charging plan, generate a charging command corresponding to the charging power and the charging times determined in the charging plan, and transmit the charging command to the charger 272. The charger 272 at each charging site 270 may receive the charging command, and charge the electric vehicles in accordance with the charging command.

Alternatively, instead of transmitting the charging plan, the charging-related DERMS 240 may generate a charging command corresponding to the charging power and the charging times determined in the charging plan, and transmit the charging command to each charging site 270. The charger 272 at the charging site 270 may receive the charging command, and charge the electric vehicles in accordance with the charging command.

The above operation makes it possible to supply power for charging electric vehicles in accordance with the power capacity of the system facilities, contributing to the stable operation of the power system 280. It is also possible to flexibly plan charging in accordance with the constraint condition for the plurality of charging sites 270. Thus, it is possible to achieve both stable operation of the power system 280 and efficient charging of electric vehicles.

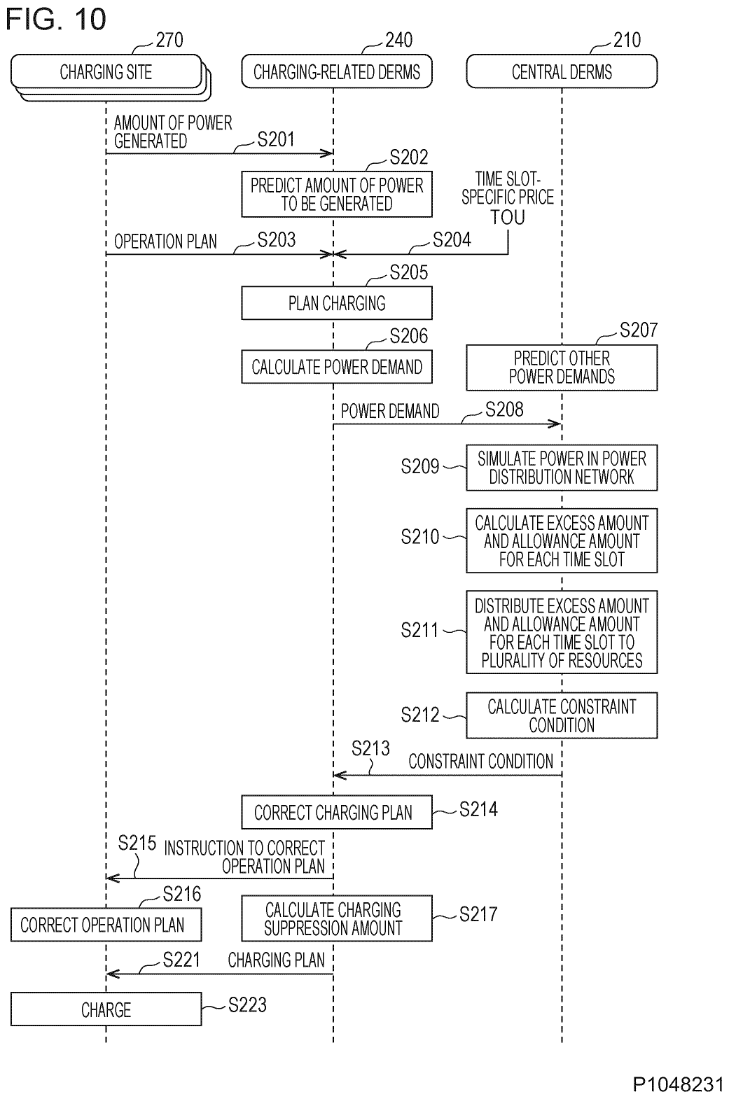

FIG. 10 is a sequence diagram illustrating a second specific example of operation of the power control system 200 illustrated in FIG. 8.

In the example in FIG. 10, when the power demand for the electric vehicles at the charging site 270 is not met, the charging-related DERMS 240 transmits an instruction to correct the operation plan to the charging site 270, and the charging site 270 receives the instruction to correct the operation plan from the charging-related DERMS 240 (S215). The charging site 270, or a management system for electric vehicles related to the charging site 270 (e.g., an operation management system of a delivery company), corrects the operation plan for the electric vehicles in accordance with the correction instruction (S216).

For example, when the charging demand for the electric vehicles cannot be met at 1:00 p.m., the operation plan is corrected such that charging can be started at 0:00 p.m. by reducing the amount to be delivered in the morning.

While an instruction to correct the operation plan is transmitted before a charging suppression amount is calculated in the example in FIG. 10, an instruction to correct the operation plan may be transmitted after a charging suppression amount is calculated. The correction instruction may include information indicating the charging suppression amount. The operation plan for the electric vehicles may be corrected in accordance with the charging suppression amount. Alternatively, the corrected charging plan may be transmitted as an instruction to correct the operating plan. The operation plan for the electric vehicles may be corrected in accordance with the corrected charging plan.

Alternatively, the charging-related DERMS 240 and the charging site 270 may correct the operation plan, the power receiving plan, and the charging plan such that the constraint condition is met while exchanging information on the operation plan, the power receiving plan, and the charging plan.

For example, the operation plan, the power receiving plan, and the charging plan affect each other. Specifically, there is a possibility that a correction of the operation plan causes corrections of the power receiving plan and the charging plan. In addition, there is a possibility that corrections of the power receiving plan and the charging plan causes a correction of the operation plan again. Thus, the charging-related DERMS 240 and the charging site 270 may search for an operation plan, a power receiving plan, and a charging plan that meet the constraint condition while adjusting the operation plan, the power receiving plan, and the charging plan little by little.

Alternatively, the processes from the transmission of the operation plan (S203) to the correction of the operation plan (S216) may be repeatedly performed such that the power demand for the electric vehicles and the constraint condition are met.

In the example in FIG. 10, the other operations are the same as those in the example in FIG. 9.

This makes it possible to correct the operation plan for the electric vehicles in order for the power system 280 to operate stably. It is possible to achieve both stable operation of the power system 280 and efficient charging of electric vehicles, and to operate the electric vehicles in accordance with an efficient operation plan.

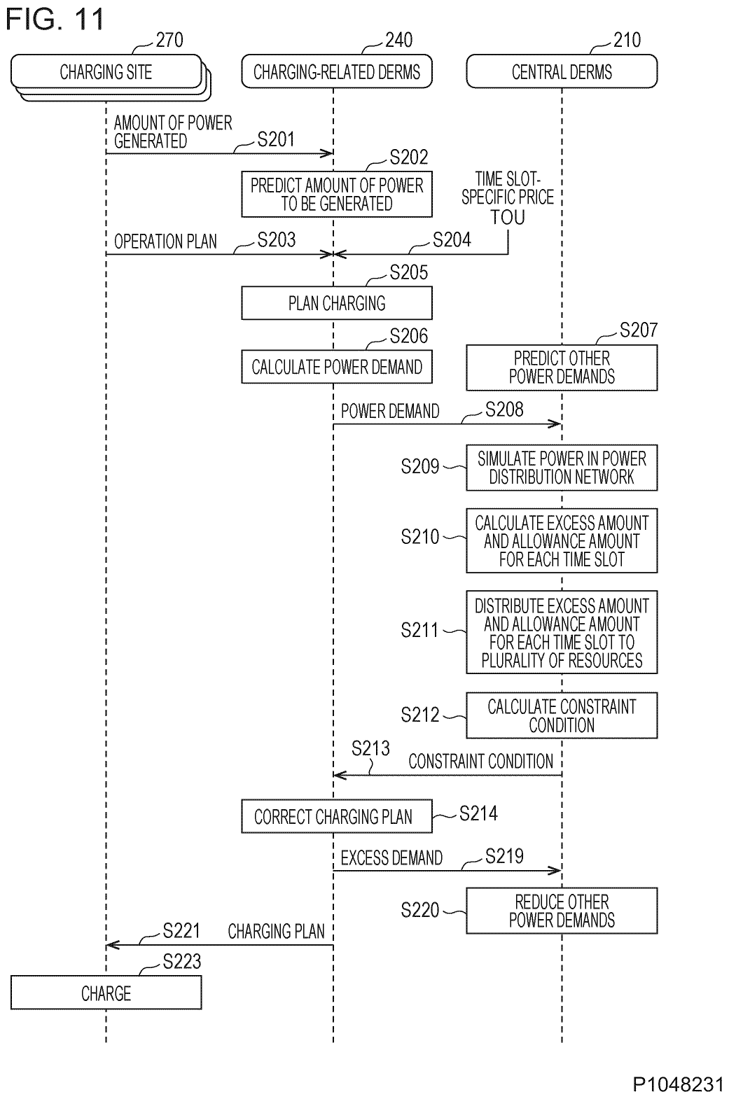

FIG. 11 is a sequence diagram illustrating a third specific example of operation of the power control system 200 illustrated in FIG. 8. In the example in FIG. 11, when the power demand for the electric vehicles at the charging site 270 is not met, the charging power at the charging site 270 at which the power demand for the electric vehicles is not met is not suppressed, and operation to reduce other power demands is performed.

That is, in the example in FIG. 11, compared to the example in FIG. 9, when the power demand for the electric vehicles at the charging site 270 is not met, a charging suppression amount is not calculated. In this case, the charging-related DERMS 240 transmits information indicating an excess demand with respect to the constraint condition to the central DERMS 210, and the central DERMS 210 receives the information indicating an excess demand with respect to the constraint condition from the charging-related DERMS 240 (S219).

The central DERMS 210 performs a process of reducing the other power demands in accordance with the excess demand (S220). For example, the central DERMS 210 may decrease the amount of power supplied from the power system 280 and consumed by the housing facilities 250 and the industrial facilities 260, and reduce the other power demands for the power system 280. At this time, the central DERMS 210 may perform a process of compensating for the other power demands for the power system 280 that have been reduced, by increasing the amount of the power to be supplied from the distributed power source to the housing facilities 250 and the industrial facilities 260.

After receiving the information indicating an excess demand from the charging-related DERMS 240, the central DERMS 210 may determine whether or not the excess demand is recognized on the basis of the other power demands, etc., and transmit the results of determining whether or not an excess demand is recognized to the charging-related DERMS 240. When the excess demand is not recognized, the charging-related DERMS 240 may transmit a corrected charging plan that does not meet the power demand for the electric vehicles to the charging site 270 as in the example in FIG. 9, or may transmit an instruction to correct the operation plan to the charging site 270 as in the example in FIG. 10.

After receiving the information indicating an excess demand from the charging-related DERMS 240, the central DERMS 210 may determine a new constraint condition on the basis of the excess demand, the other power demands, etc., and transmit information indicating the new constraint condition to the charging-related DERMS 240. The charging-related DERMS 240 may correct the charging plan in accordance with the new constraint condition.

In the example in FIG. 11, the other operations are the same as those in the example in FIG. 9.

This increases the number of cases where the power demand for the electric vehicles is met. Thus, it is possible to efficiently operate the electric vehicles.

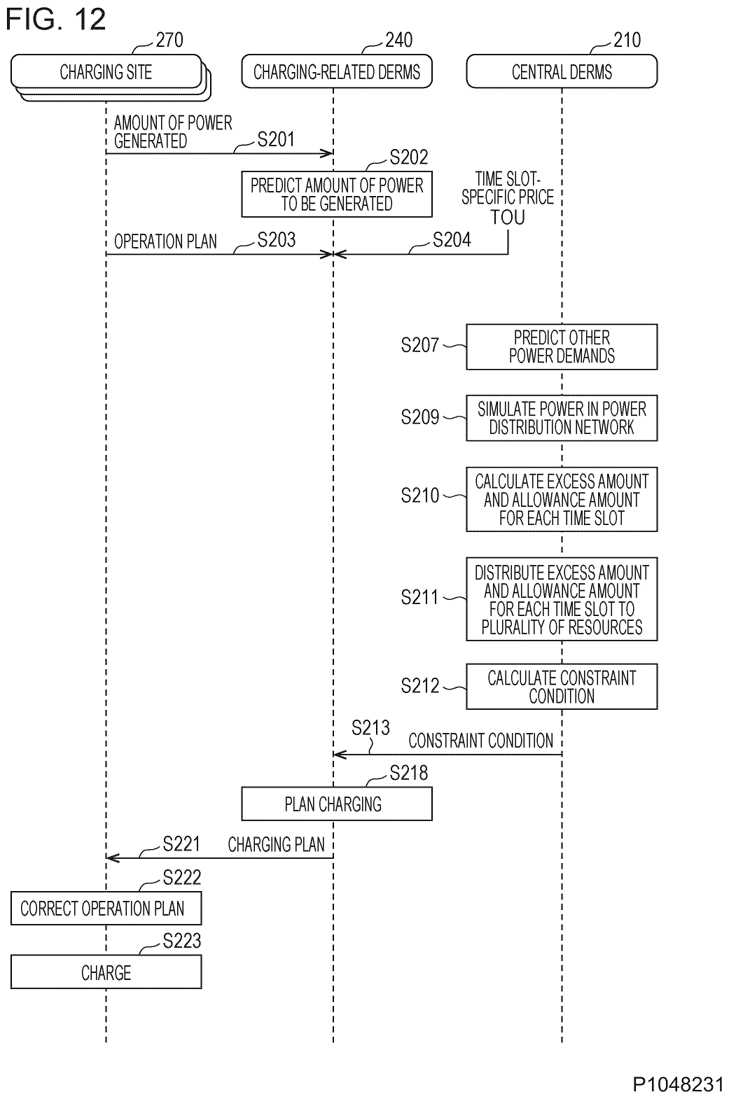

FIG. 12 is a sequence diagram illustrating a fourth specific example of operation of the power control system 200 illustrated in FIG. 8. In the example in FIG. 12, a plurality of processes are integrated and simplified.

Specifically, first, each charging site 270 transmits information indicating the amount of power generated in the past to the charging-related DERMS 240, and the charging-related DERMS 240 receives the information indicating the amount of power generated in the past from each charging site 270 (S201). Next, the charging-related DERMS 240 predicts the amount of power to be generated at each charging site 270 in the future (S202). Each charging site 270 transmits an operation plan to the charging-related DERMS 240, and the charging-related DERMS 240 receives the operation plan from each charging site 270 (S203). These operations are the same as those in the example in FIG. 9.

The charging-related DERMS 240 acquires a time slot-specific price (TOU) from a power company (S204). This operation also is the same as that in the example in FIG. 9.

On the other hand, the central DERMS 210 predicts other power demands for each time slot (S207). The other power demands are power demands other than the power demand for charging electric vehicles. The central DERMS 210 simulates the power in the power distribution network on the basis of the other power demands (S209). That is, in the example in FIG. 12, the power in the power distribution network is simulated without considering the power demand for charging electric vehicles.

The central DERMS 210 may predict a power demand including the power demand for charging electric vehicles for each time slot (S207). For example, the central DERMS 210 may predict a power demand including the power demand for charging electric vehicles for each time slot using the power demand for electric vehicles in the past, without using the operation plan. The central DERMS 210 may simulate the power in the power distribution network on the basis of the predicted power demand (S209).

Next, the central DERMS 210 calculates an excess amount and an allowance amount of the power flowing through the system facilities in the power distribution network with respect to the power capacity of the system facilities for each time slot in the simulation of the power in the power distribution network (S210). Next, the central DERMS 210 distributes the excess amount and the allowance amount for each time slot to a plurality of resources (S211). These operations are the same as those in the example in FIG. 9.

The central DERMS 210 calculates a constraint condition for a group of charging sites in accordance with the results of the distribution of the excess amount and the allowance amount for each time slot (S212). For example, the constraint condition is expressed as “charging sites a+b=3000 kW@1 PM, charging sites a+b=4000 kW@2 PM, . . . , charging sites a+b+c=35000 kW@1 PM, . . . ”, etc.

For example “charging sites a+b=3000 kW@ 1 PM” indicates that the upper limit of the power that can be supplied from the power system 280 to the charging sites a and b at 1:00 p.m. is 3000 kW. “Charging sites a+b=4000 kW@2 PM” indicates that the upper limit of the power that can be supplied from the power system 280 to the charging sites a and b at 2:00 p.m. is 4000 kW. “Charging sites a+b+c=35000 kW@1 PM” indicates that the upper limit of the power that can be supplied from the power system 280 to the charging sites a, b, and c at 1:00 p.m. is 35000 kW.

That is, in the example in FIG. 12, the constraint condition is expressed as the absolute magnitude, rather than the difference from the power demand. As in the example in FIG. 9, the constraint condition may be determined for all the charging sites 270. Alternatively, the constraint condition may be determined for some charging sites 270 that share common system facilities, rather than for all the charging sites 270.

A plurality of constraint conditions may be determined for the same time for one charging site 270. For example, “charging sites a+b=3000 kW@1 PM” and “charging sites a+b+c=35000 kW@1 PM” may be determined at the same time. The former is a constraint condition for system facilities related to the power demand for the charging sites a and b, and the latter is a constraint condition for system facilities related to the power demand for the charging sites a, b, and c in a wider area.

Next, the central DERMS 210 transmits information indicating the constraint condition to the charging-related DERMS 240, and the charging-related DERMS 240 receives the information indicating the constraint condition from the central DERMS 210 (S213). This operation is the same as that in the example in FIG. 9.

The charging-related DERMS 240 plans charging of electric vehicles at each charging site 270 on the basis of the amount of power to be generated, the operation plan, the time slot-specific price, etc. (S218). The charging-related DERMS 240 may plan charging of electric vehicles at each charging site 270 further on the basis of the state of charge of the power storage device 274, in addition to the amount of power to be generated, the operation plan, and the time slot-specific price. In the example in FIG. 12, the charging-related DERMS 240 plans charging of electric vehicles at each charging site 270 such that the constraint condition is met.

For example, the charging-related DERMS 240 generates a power receiving plan and a charging plan for each charging site 270 such that the total of the power to be supplied from the power system 280 to the plurality of charging sites 270 in each time slot is less than or equal to the upper limit value determined for the time slot.

Specifically, the charging-related DERMS 240 may generate a power receiving plan and a charging plan for each charging site 270 such that the total of the power to be supplied from the power system 280 to the plurality of charging sites 270 in the first time slot is less than or equal to the upper limit value determined for the first time slot. A power demand that exceeds the upper limit value for the first time slot may be compensated for with the power from the distributed power source, or may be compensated for with the power to be received in a time slot different from the first time slot.

The charging-related DERMS 240 may generate a power receiving plan and a charging plan such that the power demand for the electric vehicles at each charging site 270 is met.

However, if the power demand for the electric vehicles is not met when the charging-related DERMS 240 generates a charging plan such that the constraint condition is met, the charging-related DERMS 240 may generate a charging plan such that the constraint condition is met by suppressing the charging power, even if the power demand for the electric vehicles is not met. At this time, an amount of power that could not be compensated for with the power from the distributed power source or the power to be received in a time slot different from the first time slot, of the amount of the power to be received decreased by correcting the power receiving plan such that the total of the power to be supplied to the plurality of charging sites 270 is less than or equal to the upper limit for the first time slot, may be calculated as a charging suppression amount.

After that, the charging-related DERMS 240 transmits the charging plan to each charging site 270, and each charging site 270 receives the charging plan (S221). This operation is the same as that in the example in FIG. 9. Each charging site 270 may correct the operation plan in accordance with the charging plan (S222). That is, the charging plan may correspond to the instruction to correct the operation plan, and each charging site 270 may correct the operation plan such that the charging suppression amount decreases.

As in the example in FIG. 11, the charging-related DERMS 240 may transmit information indicating an excess demand with respect to the constraint condition to the central DERMS 210. The central DERMS 210 may perform a process of reducing the other power demands in accordance with the excess demand.

Each charging site 270 charges the electric vehicles in accordance with the charging plan (S223). This operation is the same as that in the example in FIG. 9.

In the example in FIG. 12, the constraint condition does not reflect the operation plan. However, the processes are simplified. Thus, it is possible to efficiently generate a charging plan.

While aspects of the charging planning device have been described above in accordance with the embodiments, the aspects of the charging planning device are not limited to the embodiments. The embodiments may be modified as conceived of by a person skilled in the art, or a plurality of constituent elements in the embodiments may be combined as desired.

For example, a process executed by a particular constituent element in the embodiments may be executed by another constituent element instead of the particular constituent element. The order of a plurality of processes may be changed, or a plurality of processes may be executed concurrently. Ordinal numbers such as “first” and “second” that are used in the description may be replaced, removed, or newly added as appropriate. These ordinal numbers do not necessarily correspond to a meaningful order, and may be used to identify elements.

A charging planning method including the steps performed by the constituent elements of the charging planning device may be executed by any system or device. That is, this charging planning method may be executed by the charging planning device described above, or may be executed by another system or device.

For example, a part or all of the charging planning method may be executed by a computer that includes a processor, a memory, input and output circuits, etc. In that event, the charging planning method may be executed by the computer by executing a program that allows the computer to execute the charging planning method.

For example, the above program causes a computer to execute a charging planning method performed by a charging planning device, including carrying out a first charging plan for a predetermined period for each of a plurality of charging sites that are connected to a power system and that charge electric vehicles, in which the first charging plan is carried out such that a total of power to be received from the power system at the plurality of charging sites is less than or equal to an upper limit that is less than or equal to a power capacity of system facilities.

The above program may be stored in a non-transitory computer-readable storage medium such as a CD-ROM.

The constituent elements of the charging planning device may be constituted by dedicated hardware, may be constituted by general-purpose hardware that executes the above program, etc., or may be constituted by a combination of these. The general-purpose hardware may be constituted by a memory that stores a program, a general-purpose processor that reads a program from the memory and executes the program, etc. Here, the memory may be a semiconductor memory, a hard disk, etc., and the general-purpose processor may be a CPU, etc.

The dedicated hardware may be constituted by a memory, a dedicated processor, etc. For example, the dedicated processor may execute the above charging planning method by referencing the memory.

The constituent elements of the charging planning device may be electrical circuits. These electrical circuits may constitute a single electrical circuit as a whole, or may be separate electrical circuits. These electrical circuits may correspond to dedicated hardware, or may correspond to general-purpose hardware that executes the above program, etc.

The present disclosure can be used as a charging planning method that achieves both stable operation of a power system and efficient charging of electric vehicles, and can be applied to a charging planning device, etc., that plans charging of electric vehicles at each of a plurality of charging sites.

What is claimed is:

1. A charging planning method performed by a charging planning device, comprising
carrying out a first charging plan for a predetermined period for each of a plurality of charging sites that are connected to a power system and that charge electric vehicles,
wherein the first charging plan is carried out such that a total of power to be received from the power system at the plurality of charging sites is less than or equal to an upper limit that is less than or equal to a power capacity of system facilities.

2. The charging planning method according to claim 1,
wherein the upper limit is provided for each time slot within the predetermined period.

3. The charging planning method according to claim 1,
wherein in the first charging plan, charging of the electric vehicles is planned such that a ratio of power to be received from the power system to charging power of at least one charger provided at a charging site is greater in a time slot with a lower unit power price than in a time slot with a higher unit power price, among two time slots with different unit power prices.

4. The charging planning method according to claim 1,
wherein in the first charging plan, charging of the electric vehicles is planned such that a ratio of power to be received from a distributed power source provided at a charging site to charging power of at least one charger provided at the charging site is greater in a time slot with a higher unit power price than in a time slot with a lower unit power price, among two time slots with different unit power prices.

5. The charging planning method according to claim 1, further comprising
acquiring an operation plan for the electric vehicles,
wherein the first charging plan is carried out such that a power demand for the electric vehicles is met in a time slot in which the electric vehicles are chargeable and which is set on a basis of the operation plan for the electric vehicles.

6. The charging planning method according to claim 5, further comprising
determining a charger to charge the electric vehicles on a basis of a time slot in which the electric vehicles are chargeable.

7. The charging planning method according to claim 1, further comprising
receiving information indicating the upper limit from a management system that manages power to be transmitted from the power system.

8. The charging planning method according to claim 7, further comprising:
carrying out a second charging plan such that a power demand for the electric vehicles for the predetermined period is met for each of the plurality of charging sites without considering the upper limit,
the second charging plan including planning first power to be received from the power system, which is included in charging power for the electric vehicles; and
transmitting a power receiving plan to the management system, the power receiving plan being a plan for power to be received from the power system, including the first power to be received, for each of the plurality of charging sites,
wherein the upper limit is determined by the management system on a basis of the power receiving plan received by the management system.

9. The charging planning method according to claim 1, further comprising:
carrying out a second charging plan such that a power demand for the electric vehicles for the predetermined period is met for each of the plurality of charging sites without considering the upper limit,
the second charging plan including planning first power to be received from the power system, which is included in charging power for the electric vehicles; and
determining the upper limit on a basis of a power receiving plan, which is a plan for power to be received from the power system, including the first power to be received, for each of the plurality of charging sites.

10. The charging planning method according to claim 1, further comprising determining the upper limit on a basis of the power capacity of the system facilities and power to be transmitted from the power system.

11. The charging planning method according to claim 8,
wherein the upper limit includes a first upper limit value that is set for a first time slot within the predetermined period, the first upper limit value being less than a peak value of the total of the power to be received from the power system at the plurality of charging sites in the first time slot.

12. The charging planning method according to claim 11,
wherein in the first charging plan, the power receiving plan is corrected such that the total in the first time slot is less than or equal to the first upper limit, and a charging plan for at least one of the plurality of charging sites is corrected such that at least a part of an amount of power to be received that has been decreased by correcting the power receiving plan is compensated for with power from a distributed power source provided at the charging site.

13. The charging planning method according to claim 11,
wherein in the first charging plan, the power receiving plan is corrected such that the total in the first time slot is less than or equal to the first upper limit, and a charging plan for at least one of the plurality of charging sites is corrected such that at least a part of an amount of power to be received that has been decreased by correcting the power receiving plan is compensated for with power to be received from the power system in a time slot different from the first time slot.

14. The charging planning method according to claim 8,
wherein in the second charging plan, charging of the electric vehicles is planned such that a ratio of power to be received from the power system to charging power of at least one charger provided at a charging site is greater in a time slot with a lower unit power price than in a time slot with a higher unit power price, among two time slots with different unit power prices.

15. The charging planning method according to claim 8,
wherein in the second charging plan, charging of the electric vehicles is planned such that a ratio of power to be received from a distributed power source provided at a charging site to charging power of at least one charger provided at the charging site is greater in a time slot with a higher unit power price than in a time slot with a lower unit power price, among two time slots with different unit power prices.

16. The charging planning method according to claim 12,
wherein in the first charging plan, the power to be received in the first time slot is downwardly corrected preferentially for a charging site provided with a distributed power source, among the plurality of charging sites, and a charging plan for at least one of the plurality of charging sites is corrected such that an amount of power to be received that has been decreased by downwardly correcting the power to be received is compensated for with power from the distributed power source provided at the charging site.

17. The charging planning method according to claim 13,
wherein in the first charging plan, the power to be received in the first time slot is downwardly corrected preferentially for a charging site with a lower unit price of power to be received from the power system in a time slot different from the first time slot, among the plurality of charging sites, and a charging plan for at least one of the plurality of charging sites is corrected such that an amount of power to be received that has been decreased by downwardly correcting the power to be received is compensated for with power to be received from the power system in the different time slot.

18. The charging planning method according to claim 11,
wherein in the first charging plan, the power receiving plan is corrected such that the total in the first time slot is less than or equal to the first upper limit, and when a charging plan is corrected such that an amount of power to be received that has been decreased by correcting the power receiving plan is compensated for with at least one of power from a distributed power source provided at a charging site and power to be received from the power system in a time slot different from the first time slot, charging plans for the plurality of charging sites is corrected such that an increasing charging cost at each of the plurality of charging sites is equalized among the plurality of charging sites.

19. The charging planning method according to claim 11,
wherein in the first charging plan,
even when a power demand for the electric vehicles is not met as an amount of power to be received that has been decreased by correcting the power receiving plan cannot be compensated for with at least one of power from a distributed power source provided at a charging site and power to be received from the power system in a time slot different from the first time slot when the power receiving plan is corrected such that the total in the first time slot is less than or equal to the first upper limit,
a charging plan for at least one of the plurality of charging sites is corrected such that the total in the first time slot is less than or equal to the first upper limit value.

20. The charging planning method according to claim 11, further comprising
outputting an instruction to correct an operation plan for the electric vehicles when a power demand for the electric vehicles is not met as an amount of power to be received that has been decreased by correcting the power receiving plan cannot be compensated for with at least one of power from a distributed power source provided at a charging site and power to be received from the power system in a time slot different from the first time slot when the power receiving plan is corrected such that the total in the first time slot is less than or equal to the first upper limit.

21. The charging planning method according to claim 11, further comprising
when a power demand for the electric vehicles is not met as an amount of power to be received that has been decreased by correcting the power receiving plan cannot be compensated for with at least one of power from a distributed power source provided at a charging site and power to be received from the power system in a time slot different from the first time slot when the power receiving plan is corrected such that the total in the first time slot is less than or equal to the first upper limit, transmitting, to the management system that manages power to be transmitted from the power system, information indicating an amount of power that could not be compensated for with at least one of the power from the distributed power source provided at the charging site and the power to be received from the power system in the time slot different from the first time slot, of the amount of the power to be received decreased by correcting the power receiving plan.

22. The charging planning method according to claim 19,
wherein in the first charging plan, an amount obtained by dividing an amount of power that could not be compensated for with at least one of the power from the distributed power source provided at the charging site and the power to be received from the power system in the time slot different from the first time slot, of the amount of the power to be received decreased by correcting the power receiving plan, equally by a number of the plurality of charging sites, is decreased from an amount of power to be received in the first time slot at each of the plurality of charging sites, which is planned to be received from the power system in the first time slot in the power receiving plan.

23. The charging planning method according to claim 11,
wherein the first time slot is a time slot in which a unit price of power to be received from the power system is lower than that in a time slot different from the first time slot.

24. The charging planning method according to claim 13,
wherein the upper limit includes a second upper limit value that is set for a second time slot within the predetermined period, the second upper limit value being greater than a peak value of the total of the power to be received at the plurality of charging sites in the second time slot in the power receiving plan, and
the time slot different from the first time slot is the second time slot.

25. A charging planning device comprising:
a controller that carries out a first charging plan for a predetermined period for each of a plurality of charging sites that are connected to a system section of a power system and that charge electric vehicles; and
a storage that stores a constraint condition that makes a total of power to be received from the power system at the plurality of charging sites less than or equal to an upper limit that is less than or equal to a power capacity of system facilities,
wherein the controller carries out the first charging plan such that the constraint condition is met.
